(19) United States
(12) Patent Application Publication
(10) Pub. No.: US 2016/0324081 A1
(43) Pub. Date: Nov. 10, 2016

(54) PLANT SUPPORT APPARATUS AND RELATED METHODS

(71) Applicant: Russell A. Johnson, Fairfield, OH (US)

(72) Inventor: Russell A. Johnson, Fairfield, OH (US)

(21) Appl. No.: 15/146,796

(22) Filed: May 4, 2016

Related U.S. Application Data
(60) Provisional application No. 62/156,385, filed on May 4, 2015.

(51) Int. Cl. A01G 17/04; A01G 7/04

(52) U.S. Cl. CPC A01G 17/04; A01G 7/045

(57) ABSTRACT

Apparatus and methods for an adjustable plant support comprising a plurality of modular components that can be arranged in various configurations and dimensions to accommodate different sized and shaped plants, and can be adjusted over time in relation to the plant and its growth or other changes. When assembled, the plant support creates a dynamic frame for supporting a plant over its life and/or guiding the direction of growth of a plant and/or limiting its growth in one or more directions.

### CROSS REFERENCE TO RELATED APPLICATION

The present application is related to and claims the benefit of U.S. Provisional Application Ser. No. 62/156,385, filed May 4, 2015, entitled “Plant Support”, the contents of which are incorporated herein in their entirety.

### FIELD OF THE INVENTION

The present invention is directed to a plant support and more particularly, to a plant support that is formed from a plurality of components that when assembled provides a support for growing plants and which can be easily adjusted or modified to accommodate a plant as it grows or to direct the plant to grow in a specific direction or fashion. The plant support preferably is modular, and related methods are facilitated by that modularity and other aspects of the invention.

### BACKGROUND

Plant supports have existed in the prior art, for various purposes and with various related limitations. For example, plant supports in the form of hanging baskets designed to hang from ceilings and other similar structures typically have means for supporting a pot such as by wires that attach to the upper rim of the pot or form a pocket whereby the pot can be supported from the bottom. Such plant supports are often formed from relatively stiff wires that extend generally upwardly from the upper rim of the pot, and have a hook or hanger for attaching such that the baskets hang vertically from a structure. Such hanging basket structures either provide little support for the growth of the plant or are unable or have a limited ability to be modified, enlarged, or adjusted.

Plant forms (such as topiary forms for training plants to grow in various architectural, sculptural, geometric, and animal shapes) have been developed and are formed from various forms of support members that are adapted to be positioned over a plant (usually when the plant is small) to provide a frame and/or guide for protecting, bending, cutting, clipping, pruning, and/or shearing the plant, such that the plant eventually takes the shape desired by the gardener. Such forms typically are used to provide a frame to direct the growth of the plant and are not necessarily intended to supply support for the plant itself. Further, such systems typically are designed for a particular plant and design and again are unable to or have a limited ability to be modified, enlarged, or adjusted as the plant grows. Tomato cages and the like also exist, but have various shortcomings.

Accordingly, it would be desirable to have a plant support system and methods that can be used in a variety of ways and for a plurality of plants; which can be placed along the side of and/or in a pot or other container or placed free-standing in a garden; that readily can be configured in a wide range of arrangements (from simple to complex) and sized for various sizes and numbers of plants; that can be easily adjusted or modified to accommodate the plant as it grows or is trimmed or other plants or added or removed in the vicinity; that enhances the growth of vegetation by providing a supporting structure that allows plants to grow and entwine themselves through the various support structures, that operates to direct and support plant growth and prevents or minimizes the risk of injury to the plant; and that occupies minimal space in the area that the plant is growing.

### SUMMARY

The present inventions relate to an adjustable, modular plant support system, comprising a plurality of preferably standardized components that can be combined and/or arranged in various configurations and dimensions to accommodate different size and shaped plants, and a variety of gardening goals related to those plants. Preferably, the components include one or more generally vertical posts, one or more generally horizontal support rods, and other elements to permit customized assembly, adjustment, retention, and other configuration and uses of the systems. Among the many applications for the invention, the components can be placed beside and/or around one or more plants, in paths or other patterns (linear, sinusoidal, random, etc.), and many other configurations. The components preferably are made from lightweight, durable, and sufficiently strong materials to serve the purposes and needs for the many applications in which the inventions can be deployed. Although many of the embodiments herein are described and shown on generally flat installations, persons of ordinary skill in the art will understand that the invention can be readily used on undulating, terraced, or other landscapes or hardscapes, and (among other things) can provide matrices for plant support and guidance that extend across one or more elevations of land/plantings.

In a preferred embodiment of the invention, the plant support, when assembled, creates a frame for supporting a plant.

In another preferred embodiment of the invention, the plant support when assembled, includes one or more structures for supporting and guiding the direction of growth of a plant, holding one or more plants away from a certain area (such as a walkway or gate), and the like.

In another preferred embodiment of the invention, the plant support includes at least one elongated post having a plurality of apertures for receiving one or more support rods arranged to support the plant and/or to enhance plant growth while minimizing the possibility of damage to the plant.

In a preferred embodiment of the invention, the plant support comprises stake elements associated with corresponding elongated posts and configured for insertion into the ground. Persons of ordinary skill in the art will understand that the stakes can be integrally formed with the posts, and/or adapted for mating with or otherwise being attached to those posts into a functional assembly.

In another preferred embodiment of the invention, the plant support further comprises a securing mechanism to secure an associated one or more support rods in a selected position in an aperture along an elongated post.

In a preferred embodiment of the invention the securing mechanism comprises one or more locking slots connected to the aperture, which slot can be used to help maintain the support rod in a selected position within the aperture.

In a preferred embodiment of the invention each support rod includes a first end for inserting though an aperture of a first elongated post and a second end for inserting through an aperture of a second elongated post, and a securing mechanism comprises one or more corrugated portions along first and second ends of the support rod. The corrugations preferably make the rod flexible so that it can be bent at the location of the corrugations, to form an interfering fit so that the rod will not become inadvertently dislodged from the post/aperture.

In a preferred embodiment of the invention the securing mechanism comprises an interfering or friction/compression element (such as a band, clamps, clips, pins, cords, elastic washers, or other means) effective for keeping the ends of a support rod from undesirably sliding out of engagement with the aperture.

In a preferred embodiment of the invention the securing mechanism comprises a keyed structure operating between the rod and the post, to permit selective engagement between the two elements as a desired position and in a desired relationship. Such keying can take any suitable configuration, including a plurality of grooves and/or teeth along the surface of the support rod for mating with an aperture (or a slot or other feature thereof) to secure the support rod in position with respect to the post.

In another preferred embodiment of the invention, the plant support includes a net that extends over the plant.

In a preferred embodiment of the invention the net comprises a mesh sized to reduce the likelihood of insects penetrating the net.

In a preferred embodiment of the invention the net comprises a plurality of cords for reducing the likelihood of birds from making contact with the plant.

In another preferred embodiment of the invention the plant support includes a tarp that extends over the plant.

In a preferred embodiment of the invention the tarp is a transparent or a translucent tarp.

In another preferred embodiment of the invention, one or more of the elongated posts include an upper insert for mounting to the top of a post, wherein the insert is effective for attaching to a net and/or a tarp.

In another preferred embodiment of the invention the individual posts and rods are assembled such that they are connected together to form an orientation/configuration that is conducive to the growth of a plant.

In another preferred embodiment of the invention the elongated posts and/or supporting rods are flexible such that they can bow to form an ornamental configuration.

In another preferred embodiment of the invention the individual components are assembled such that they exhibit a force along one or more portions of a plant to guide or direct the plant to grow in a specific direction.

In another preferred embodiment of the invention the plant support is formed from a plurality of individual components that fit together to produce a three-dimensional unified structure. Persons of ordinary skill in the art will understand that the complexity of such matrices can vary widely, to fit the needs of the particular application and the creativity of the gardener, among other factors.

In another preferred embodiment of the invention the plant support comprises two or more posts that can be attached or otherwise operatively coupled together to form a unified post having a desired length.

In another preferred embodiment of the invention the plant support comprises one or more lights within one or more posts. Alternatively or additionally, one or more lights may be provided within one or more support members/rods, and/or one or more starter stakes. Also, lights may be provided within one or more posts by simply placing a well-known light (such as an LED or battery-powered and/or solar-powered light) within the hollow tube of the post such that light may shine out from the apertures provided in the post when the light is turned on.

In a preferred embodiment of the invention one or more of the lights is a light, such as a plant light, that operates to emit an electromagnetic spectrum appropriate to enhance photosynthesis.

In a preferred embodiment of the invention the lights are light-emitting diodes.

These and other benefits, advantages, and embodiments of the invention will be apparent from the following description, the accompanying drawings, and the appended claims.

### BRIEF DESCRIPTION OF THE DRAWINGS

The present inventions will become apparent from the textual description considered in connection with the accompanying drawings. It should be understood, however, that the drawings are intended for the purpose of illustration and not as limits of the invention. In other words, the present invention is illustrated by way of example, and not by way of limitation, in the text and the figures of the accompanying drawings. In those drawings, like reference numerals generally refer to similar elements.

FIG. 1 is a schematic top view illustration showing a plurality of elongated posts placed within the ground forming a geometric shape, such as in a circular configuration, and having a plurality of rods supported by the elongated posts and positioned for supporting one or more plants.

FIG. 2 is a schematic top view illustration of another of the many embodiments of the plant support system of the inventions, showing the elongated posts arranged forming another geometric shape, such as a square or rectangular configuration.

FIG. 3 is a schematic top view illustration of still another of the many embodiments of the plant support apparatus of the inventions, showing the elongated posts arranged forming another geometric shape, such as in various row and/or column and/or random configurations.

FIG. 4 is a perspective view of one of the many elongated post elements that can be used to practice the present inventions. This embodiment is shown with an attachment coupler end having a generally circular opening to receive the end of a similarly sized and shaped post (or a stake or other element), and an elongated shaft portion having a generally circular cross section and a plurality of apertures longitudinally placed along the shaft portion.

FIG. 5 is a side view of the elongated post of FIG. 4.

FIG. 6 is an end view taken along line 6-6 of FIG. 4.

FIG. 7 is a perspective view showing another of the many embodiments of an elongated post usable to practice the inventions, having a shaft portion formed from generally perpendicular walls and having a plurality of apertures longitudinally placed along the perpendicular walls and an attachment coupler having a circular cross section.

FIG. 7A is an end view taken along line A-A of FIG. 7.

FIGS. 7B and 7C are similar to FIG. 7A, but show an attachment coupler having alternative configurations.

FIG. 8 is a perspective view showing an elongated post similar to that of FIG. 7, having a shaft portion formed from perpendicular walls and having a plurality of apertures longitudinally placed along the perpendicular walls, and showing another of the many different attachment couplers that can be used to assemble together posts of similar cross-sectional shape and size.

FIG. 9 is a perspective view of one of the many embodiments of a support stake usable for attaching to the attachment coupler of an elongated post, for use in attaching the plant support assembly in the ground.

FIG. 10 is a perspective view of the plant support showing a plurality of elongated posts connected together by a plurality of support rods.

FIG. 10A is similar to FIG. 10, showing another of the many possible configurations of elongated posts being connected together by a plurality of support rods.

FIG. 11 is a side view of the plant support of FIG. 10 showing a plant winding in and out between the support rods.

FIG. 11A is a side view of the plant support of FIG. 10A showing the horizontal rods being bowed around each side of the plants.

FIG. 12 is a perspective schematic view showing another of the many embodiments of the plant support systems and methods of the invention, showing a plurality of elongated posts and a plurality of support rods connecting the elongated posts.

FIG. 13 is a side schematic view showing another of the many configurations into which the components of the inventions can be usefully assembled, including a plurality of elongated posts having attachment couplers for attaching additional elongated post elements to increase the height of the plant support.

FIG. 14 is a side view of another of the many embodiments of an elongated post usable to practice the inventions, showing a plurality of apertures having a securing mechanism for securing a support rod within the aperture, the securing mechanism comprising a slot extending radially outwardly from the aperture.

FIG. 15 is an enlarged view taken along line A-A of FIG. 14.

FIG. 16 is a side view of another of the many embodiments of a support rod usable in practicing the inventions, having another embodiment of a securing mechanism for securing the support rod within an aperture of the elongated post, the support rod shown in an unbent/linear configuration.

FIG. 17 is an enlarged view taken along line B-B of FIG. 16.

FIG. 18 is a side view of the of the support rod of FIG. 16 shown in a bent configuration (with ghostlines illustrating the rod ends in an alternative linear position such as shown in FIG. 16).

FIG. 19 is an enlarged view taken along line C-C of FIG. 18.

FIG. 20 is a perspective view of the support rod of FIG. 18.

FIG. 21 is a perspective schematic view of another embodiment of a plant support of the subject invention, showing another of the many embodiments of a securing mechanism to retain the horizontal rods in desired engagement with the vertical posts.

FIG. 21A is a perspective schematic view of still another embodiment of a plant support of the present invention, showing the plant support on a terraced landscape and providing matrices for plant support and guidance that extend across one or more elevations of land/plantings.

FIG. 22 is a perspective schematic view of another embodiments of a plant support of the subject invention, showing another of the many embodiments of an adjustable securing mechanism.

FIG. 23 is a side schematic view showing one of the many embodiments of a support pin usable in various embodiments of the inventions, comprising a mounting base that extends over or otherwise engages and is retained on the upper end of an elongated post and a support pin extending upwardly therefrom.

FIG. 24 is a side schematic view of another of the many preferred embodiments of the plant support system, having a plurality of cords attached to one or more elongated pegs at the upper end of the posts, the cords effectively forming a mesh for preventing or significantly reducing birds, and/or other animals from contacting one or more of the plants being supported by the plant support, and/or to support netting, tarps or the like which may rest on the cords. Although horizontal rods are not shown in FIG. 24, persons of ordinary skill in the art will understand that such rods can be included in various embodiments similar to that of FIG. 24.

FIG. 25 is a side schematic view of yet another preferred embodiment of the plant support, comprising a screen attached to or cooperatively positioned with one or more elongated posts and effective for preventing or reducing birds, animals, and/or insects from contacting the plant being supported. Persons of ordinary skill in the art will understand that such screening functions can be provided by the inventions regardless of whether the specific embodiment also provides a supporting or other function to the plant.

FIG. 26 is a top schematic view of another preferred embodiment of the plant support/protection system of the present inventions, comprising a covering or tarp attached to one or more elongated posts and extending over the elongated posts and secured along the ground by a plurality of stakes.

FIG. 27 is a side schematic view of another preferred embodiment of the plant support showing two or more elongated posts connected together by one or more support rods such that the elongated posts flex or bend to form a curved configuration.

FIG. 28 is a side schematic view of another preferred embodiment of the plant support showing two or more elongated posts connected together by one or more support rods such that the elongated posts flex or bend to form another curved configuration.

FIG. 29 is a side schematic view of another preferred embodiment of the plant support showing two or more elongated posts connected together by one or more support rods such that the elongated posts flex or bend to form another curved configuration.

FIG. 30 is a side schematic view of another preferred embodiment of the plant support, showing one of the many embodiments of a support stake effective for inserting into the ground or soil, and one of the many embodiments of an upper spear end configured to slide into the interior cavity of the shaft portion of an appropriately sized and shaped elongated post, and having a light source which operates to radiate light into the interior cavity such that the light shines out through apertures (and/or through the sides of the post itself, if the post material permits), thereby enhancing the ornamental appearance of the plant support and/or improving the growth of a plant.

FIGS. 31A-K illustrate other non-limiting configurations of the plant support systems of the inventions.

FIG. 32 illustrates other non-limiting configurations of the plant support.

FIG. 33 illustrates other non-limiting configurations of the plant support.

FIG. 34 is a schematic illustration of one of the many embodiments of an elongated post of the subject invention.

FIGS. 35A-D are schematic non-limiting illustrations of various preferred embodiments of securing mechanisms of the subject invention.

FIG. 36 is a schematic non-limiting illustration of various preferred embodiments of the securing mechanisms of FIGS. 35A-D, as they may be usable in various embodiments of the subject invention.

FIG. 37 is a schematic non-limiting illustration of another of the many embodiments of securing mechanisms usable in practicing the subject invention.

FIG. 37A is an enlarged view taken along line A-A of FIG. 37.

FIG. 38 is a side schematic view showing another of the many embodiments of a support pins of the subject invention.

FIG. 39 is a side schematic illustration showing another of the embodiments of elongated posts having support pins for attaching and/or supporting nets, cords, and/or tarps in a protective relationship over and/or around one or more plants.

FIG. 40 is a side schematic illustration showing another of the many embodiments of the inventions useful for attaching nets, cords, and/or tarps, or otherwise having the assembly supported against wind gusts or the like.

FIG. 41 is a schematic illustration showing yet another embodiment of the subject invention, comprising one or more nets and/or tarps.

FIGS. 42A-C are schematic illustrations of another embodiment of the present invention, comprising a single elongated post having support members retained in the apertures of the post in various configurations (one support member extending laterally in a general ring-shape in a direction opposite to the other support member). FIGS. 42A and B are elevation views, and FIG. 42C is a top view.

FIGS. 43A-C are schematic illustrations of another embodiment of the present invention comprising a single elongated post having support members retained in the apertures of the post in various configurations (both support members extending laterally in a general ring-shape in the same direction from the post). FIGS. 43A and B are elevation views, and FIG. 43C is a top view.

FIGS. 44A-E are various views (side, top, end, other end, and perspective, respectively) of one of the many embodiments of an elongated post of the subject invention assembled with one of the many support stakes usable in practicing the present inventions for securing the post in the ground.

FIGS. 45 and 45A-F are various views (side, section along line A-A of FIG. 45, section along line B-B of FIG. 45, section along line C-C of FIG. 45, end, end, and perspective, respectively) of the support stake of FIGS. 44A-E.

FIGS. 46A-B and 47A-B show other non-limiting configurations of the plant support systems of the inventions having flexible or bendable rods being supported by elongated posts.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that certain embodiment(s) of the invention(s) may be practiced without these specific details. In other instances, well-known structures and devices may be shown in representative block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” or “the invention” or “the inventions” refers to any one of the embodiments of the invention described herein, and any lawfully-covered equivalents. Furthermore, reference to various feature(s) of the “present invention” throughout this document does not mean that all claimed embodiments or methods must include the referenced feature(s).

In a preferred embodiment of the invention, the present invention is directed to a plant support system formed from a plurality of individual components that when assembled together provide a unified structure for supporting, guiding, and otherwise controlling the growth and/or location of vegetation such as a plant or a number of plants. In describing various embodiments of the inventions, specific terminology will be resorted to for the sake of clarity. However, the inventions are not intended to be limited to the specific terms so selected, and it is to be understood that each specific term is intended to include all lawful equivalents that operate in a similar manner to accomplish a similar purpose. For example, as used herein, the terms “upward” or “upwardly” refer to the direction away from the ground or the surface having the plant roots. The terms “downward” or “downwardly” refer to the direction towards the ground or the surface having the plant roots.

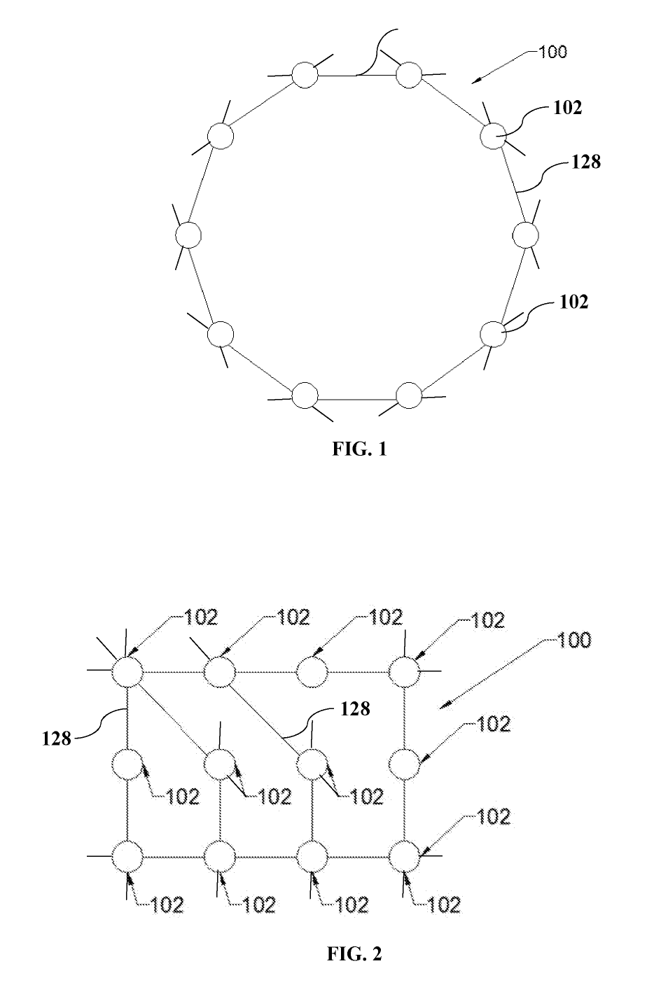

Referring to FIGS. 1-3, one of the many embodiments of the plant support or matrix 100 of the subject invention is shown comprising a plurality of individual (preferably modular) components that are assembled together to form a unified structure. Persons of ordinary skill in the art will understand that by providing the components in preferred modular configurations (as discussed herein), the inventions can be practiced in a dynamic manner, and adjusted by adding and/or removing and/or relocating various components into other locations within the assembly, based on growth of the plant(s) and/or other factors over time.

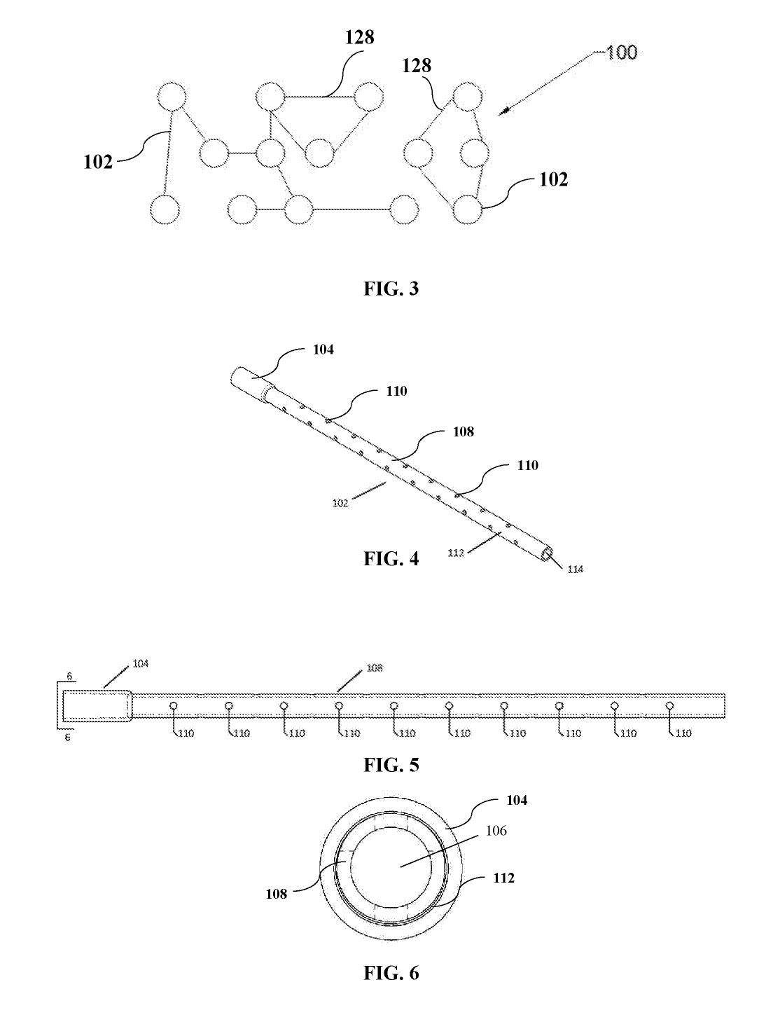

Preferably, the individual components are formed from strong, lightweight material(s), such as wood, plastic (such as PVC), or other materials. Persons of ordinary skill in the art will understand that other materials can be used, including stainless steel or other metals preferably coated to withstand weather and/or other exposure. Preferably, the components have sufficient strength to support the structure and/or the weight of the vegetation and/or wind and/or other load(s) to which the assembly and/or plant(s) may be exposed. Depending on the intended application and other factors, the plant support 100 may be formed and/or provided in a wide variety of configurations, including for example having a generally circular configuration (FIG. 1) or a generally square or rectangular configuration (FIG. 2). Again depending on the application and other factors, a plurality of elongated posts 102 preferably are positioned along the periphery of the plant support assembly and/or the plant(s), and/or within the interior of the plant(s) and/or their support shape, as shown in FIG. 2. In another of the many embodiments of the inventions, the plant support 100 is shown with a plurality of elongated posts 102 positioned in two or more generally parallel rows or random patterns (FIG. 3). It should be understood that the elongated posts can be positioned in any location to create a support system having any number of different configurations (geometric, rows, columns, or random shapes) and dimensions.

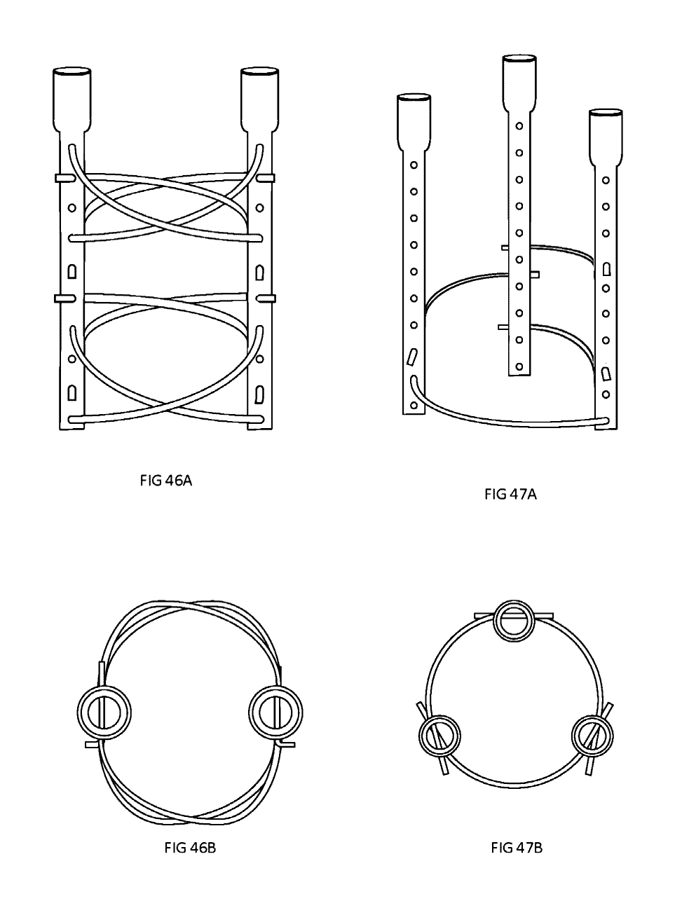

Referring to FIGS. 4-6 a perspective view of an elongated post 102 of the subject invention having a generally circular cross-section. Persons of ordinary skill in the art will understand that the invention can be practiced with solid posts, and/or with posts having other cross-sectional shapes. In FIGS. 4-6, an attachment coupler end 104 is shown with a circular opening 106. Extending from the attachment coupler 104 of the elongated post 102 is an elongated shaft portion 108. Persons of ordinary skill in the art will understand that the coupler element can be any suitable configuration to provide the coupling function(s) discussed herein, including being formed integrally with the shaft portion 108 (as shown in many of the drawings herein, such as FIGS. 46 and 47) or formed separately and attached or affixed to the shaft portion 108 by gluing, sonic welding, or any suitable method.

In the embodiment shown in FIGS. 5 and 6, the elongated shaft portion 108 has a circular cross section and a plurality of apertures 110 longitudinally placed along the shaft portion 108. As described herein, the apertures preferably are useful in connecting and assembling other elements to and/or with the posts, although as discussed herein, persons of ordinary skill in the art will understand that other mechanisms can be used rather than the apertures. As shown, in a preferred embodiment of the invention the shaft portion 108 is tubular in shape such that the apertures 110 extend from the outer surface 112 into the interior cavity 114 of the elongated shaft portion 108. For embodiments in which the post is solid rather than hollow, the apertures can pass through the entire post in a transverse manner (so that elements can be inserted through the entire solid “center” of the post(s)), or can be bored only partly into the post so as to be capable of receiving an end of a horizontal rod (again, as disclosed herein). In the latter embodiments (with holes NOT extending completely through the post) or other embodiments, the rod(s) preferably can be cut to a desired length to function for a customized installation of the inventions. Persons of ordinary skill in the art will understand that the location of the holes preferably are spaced along the length of the respective post in a generally even or regular pattern, and staggered radially about the central axis of the post (preferably as shown in a pattern such as at generally 90 degree positions), but alternatively in 45 degree positions and/or in other patterns and/or in a random arrangement. The particular size and shape and location and orientation of the apertures can be any of a wide range of suitable characteristics, and preferably are such as to facilitate desired and selective engagement with other elements as discussed herein. The holes or openings or apertures can be formed integrally during formation of the post, drilled into the post after formation, or in any other suitable manner.

Persons of ordinary skill in the art likewise will understand that the number, location, size, and/or spacing of the holes or apertures (or other connection elements or structures between the posts/rods/other components) can be any of a wide range. A convenient arrangement is having a series of generally equally-spaced and sized holes aligned vertically through the side of a post 102, with mating holes aligned on the opposite side, and a similar pair of opposing holes in rows that are 90 degrees from the first opposing pairs. In other words, in a top view of such a post, and as shown in many of the drawings herein, the holes are at 90 degree angles from each other. Persons of ordinary skill in the art will understand that such radial positioning of the holes can be any of a wide variety of other angles (such as at 45 degrees from each other), and can be random rather than in a standard repeating pattern. In certain embodiments of the inventions, a goal is to provide sufficient connection points to provide at least reasonable flexibility to users as they customize a particular installation of the inventions.

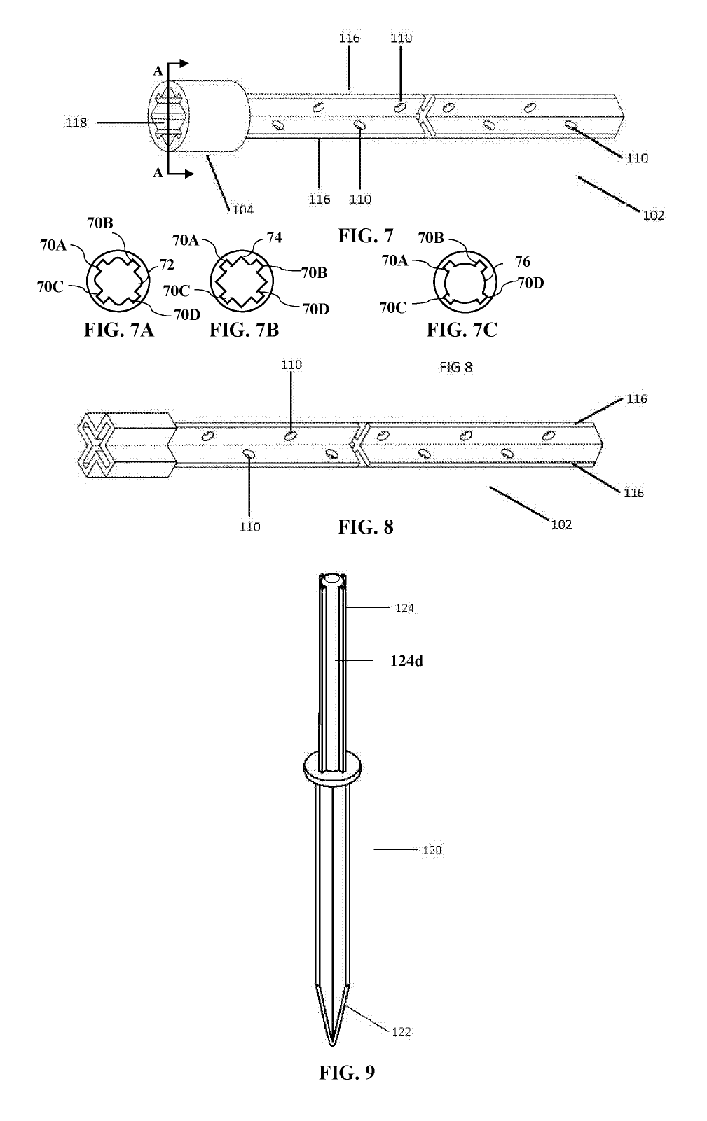

In another of the many embodiments of the invention, as illustrated in FIGS. 7 and 8, the elongated post 102 is shown with a generally X-shaped cross-section, such that the shaft portion 108 of the elongated post 102 is formed from generally perpendicular intersecting walls 116 having a plurality of apertures 110 longitudinally placed along the perpendicular walls 116. As disclosed herein, the pattern, size, shape and location(s) of the holes can be any of a wide variety. Persons of ordinary skill in the art will understand that the cross-sectional shape of the post itself can be any of a wide variety, including without limitation an L-shape or V-shape, square, rectangular, triangular, hexagonal, pentagonal, or others.

Preferably, the post is modular and can be readily joined to other similarly-sized and shaped posts (to make longer post assemblies), and/or to other elements (such as stakes, clips, net attachments, etc., as discussed herein). This coupling capability can be provided in any of a wide variety of suitable manners, including as previously mentioned via an end integrally molded on each post or by a separate element assembled to an end of a post.

By way of example, as illustrated in FIGS. 7-7A, the attachment coupler 104 can be generally circular in exterior cross-section and having a joining or locking system 118, such as interior slots 70A-D sized and shaped and configured to friction fit with the ends of respective posts and/or other elements. Persons of ordinary skill in the art will understand that the coupler 104 preferably has an interior shape sized and configured for one or more patterns of posts, such as with slot elements 70A-D for mating with the perpendicular walls 116 of a pair of elongated X-shaped cross-section posts 102 (one such post is shown engaged with the coupler 104 in FIG. 7). Persons of ordinary skill in the art will understand that the coupler 104 in FIG. 7 also can receive and grip/engage posts having a square cross-section (not shown), by contacting one or more of the various sides and corners 70A-D of the coupler's interior. Persons of ordinary skill in the art will understand that a plurality of such couplers 104 preferably are useful to configure and customize any particular embodiment or assembly of the inventions, depending on the height, width, size, and other factors relating to the plant(s), adjacent pathways, and the like. For example, and not by way of limitation, as shown in FIG. 7C, the interior shape of the coupler can be configured to mate with the top of the stake in FIG. 9, having a round periphery 124d and having exterior ridges that align with the X-shape also, or with stakes having a square (FIG. 7B) or triangle, etc. periphery and/or with exterior ridges that align with the X-shape as well to help prevent undesirable rotation of the stake with respect to the post to which it is mounted.

Among the many other coupler embodiments that may be formed integrally or separately from the posts, certain embodiments can have a generally X-shaped external cross section configuration such as shown in FIG. 8. Such embodiments can likewise include a joining or locking system 118, such as slots, for mating with the perpendicular walls 116 of another similarly sized and shaped elongated post 102 or other element. As indicated, the locking system of the attachment coupler can have any of a wide variety of configurations and can comprise various systems that operate to connect the shaft portion of one or more elongated posts (and/or rod(s)) to another elongated post or rod (even posts having different cross-sections, sizes, or the like, if the coupler is configured to receive and engage those different sizes and/or shapes, etc.). Such systems include, but are not limited to slots, detents, clips, tabs, or by frictional fitting the shaft portion within the attachment coupler.

As shown in FIGS. 1-3, the plant support 100 in operation preferably includes a plurality of elongated posts 102 arranged in a desired pattern or configuration for use in supporting and/or directing the growth of a plant. For many embodiments, the plant(s) will have roots in dirt or soil or similar material and will have a plant body extending and growing generally upwardly therefrom. For such embodiments, the material around and/or adjacent the roots is herein collectively referred to as the “ground.” As disclosed herein, the inventions preferably can be used for ground that is generally flat, as well as for terraced, sloping, or other ground conditions.

Each elongated post 102 preferably is secured to and/or supported by the ground. Such securement preferably includes a support stake 120 (FIG. 9) operatively attached to a lower end of the post 102, although as disclosed herein, no such stake is required in certain embodiments. The desired attachment can be by any suitable means, including by the support stake 120 being adapted for attaching to an attachment coupler 104 of the elongated post 102. Persons of ordinary skill in the art will understand that the stake preferably is shaped and sized and configured for use in attaching and securing the plant support 100 in the ground, in a way that is likely to provide the desired support for the associated plant(s) in view of anticipated wind, rain, irrigation, and/or other conditions. In addition and/or alternatively, the elongated post itself may be provided with a spear-shaped end configured to be inserted into the ground and/or soil.

In FIG. 9, one of the many alternative embodiments of the support stake 120 is shown as including a lower spear end 122 effective for inserting into the ground or soil and an upper spear end 124 for mating with the attachment coupler 104 of the elongated post 102. Persons of ordinary skill in the art will understand that, among the many ways the inventions can be practiced, a coupler element can be provided integrally with a stake element, so that for example a coupler like coupler 104 could be molded or otherwise provided as the upper portion of the stake in FIG. 9. The opening within the coupler preferably would be configured to receive a post or other modular element, for assembling a functional system of the inventions.

In another preferred embodiment of the invention, the upper spear end 124 is configured to slide into the interior cavity 114 of the shaft portion 108 of an elongated post 102, such as an elongated post shown in FIG. 4. Preferably, the diameter of the outer periphery 124d of the upper spear end 124 in relationship to the interior cavity 114 is such that, when the upper spear end 124 is inserted into the interior cavity 114, it forms a friction fit, thereby securing the upper spear end 124 in a desired position within the interior cavity 114. In this way the support stake 120 can be attached to an elongated post 102 without the need of an attachment coupler 104. Persons of ordinary skill in the art will understand that many other configurations of stake elements can be used when practicing the invention, and many other suitable ways of operatively attaching post members to those stakes can similarly be used. Further details of some of the many embodiments of stake elements and their assembly with posts are shown in FIGS. 44 and 45. Persons of ordinary skill in the art will understand that coupler embodiments may provide an “interference” fit (rather than just a friction fit) against relative rotation between parts such as a post and an associated stake, and therefore may be preferred for certain embodiments and applications of the inventions.

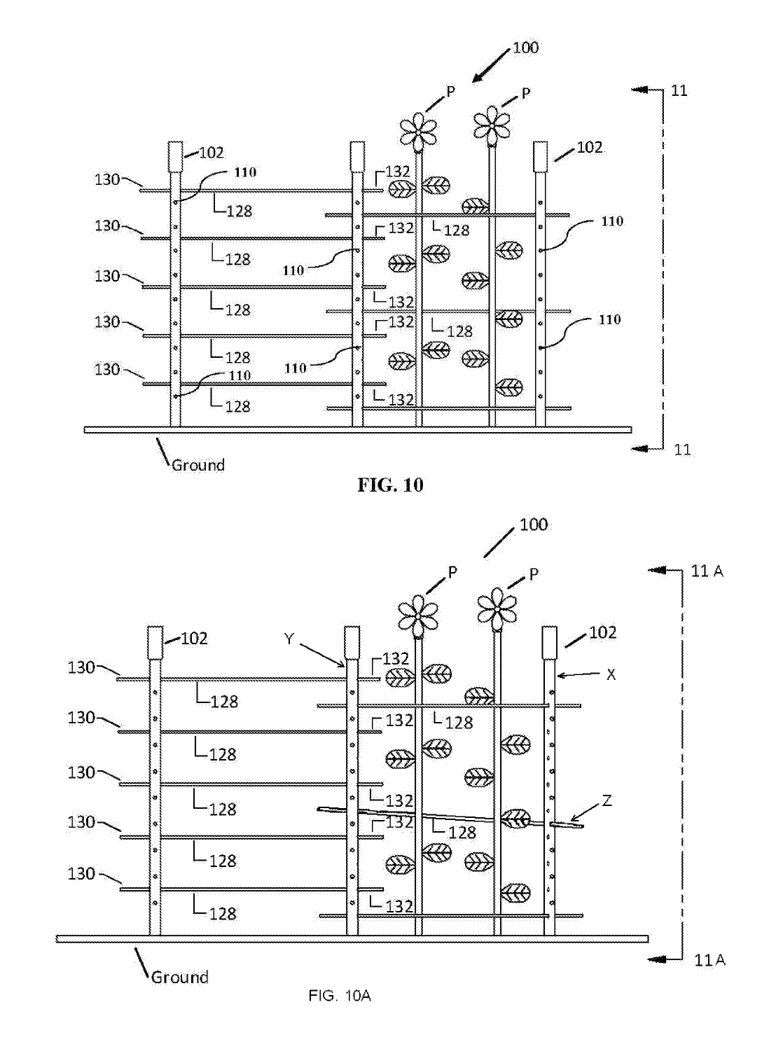

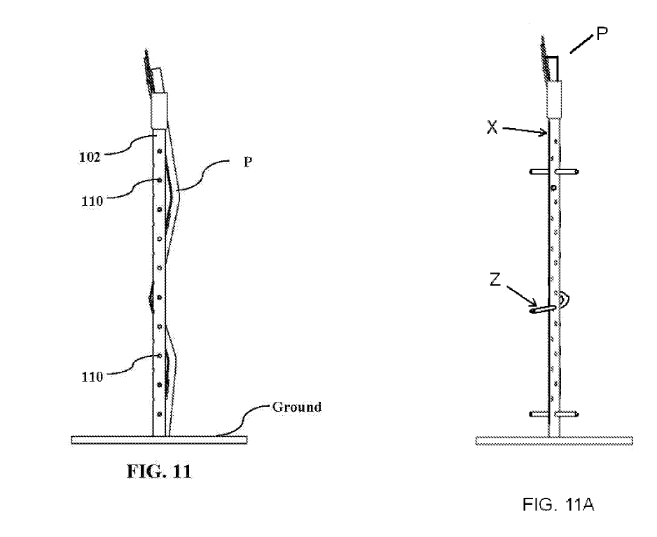

As disclosed herein, the plant support 100 preferably operates to provide support for a plant or plants as well as directing the growth of a plant or plants. Some of the many embodiments of such systems are shown in FIGS. 10-13. In a non-limiting exemplary illustration (FIGS. 10 and 11) the plant support 100 is configured such that a plurality of elongated posts 102 are arranged generally in a row, and includes a plurality of generally horizontal support rods 128. Preferably, the posts are arranged in a generally parallel orientation (generally vertical) and the rods are likewise in a generally parallel relationship with each other (although persons of ordinary skill in the art will understand that that in certain embodiments the various elements do not need to be parallel to like elements). The rods preferably interconnect with the elongated posts 102, via any suitable means. Velcro, adhesive, tape, magnets, and/or other mechanisms can be used to adhere adjacent surfaces of the rods and posts into a desired and selectable configuration. In the embodiment of FIGS. 10 and 11, a support rod 128 includes a first end 130 for inserting through an aperture 110 in the shaft portion 108 of an elongated post 102 and a second end 132 for inserting through an aperture 110 in the shaft portion 108 of another elongated post 102. Preferably, the support rods 128 can be used such that a plant P can wind in and out of the support rods 128, thereby being supported by the support rods 128, as shown in FIG. 11. Persons of ordinary skill in the art will understand that plants such as plant P alternatively can grow relatively more “straight” vertically and the support rods 128 bent out of parallel alignment and/or into a curved configuration, such as shown in FIGS. 10A and 11A.

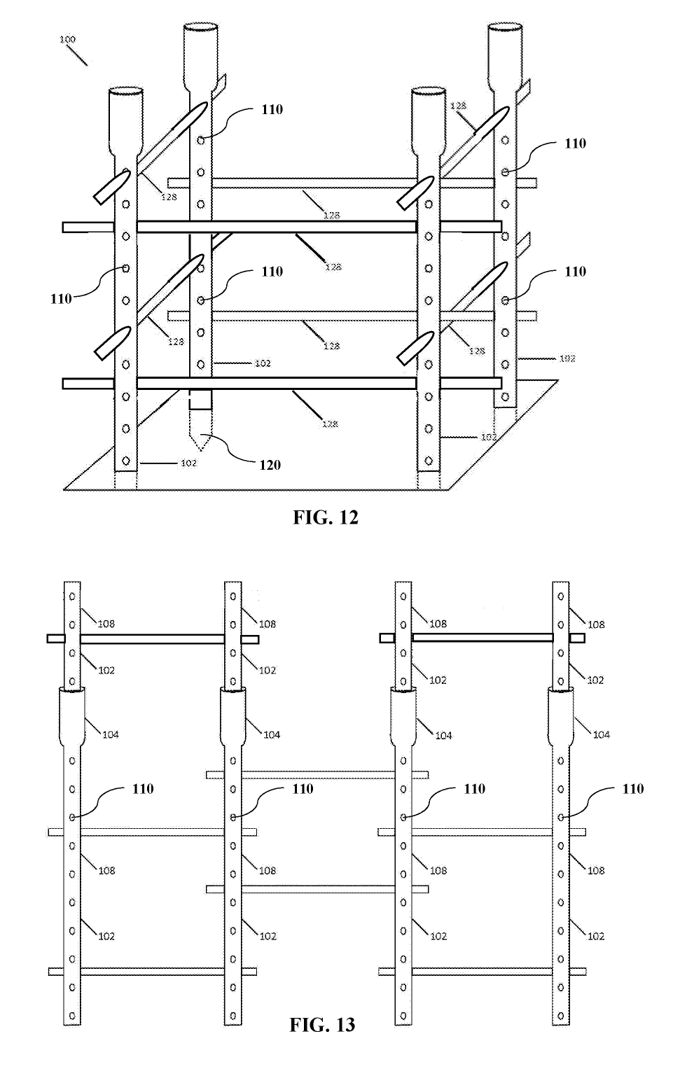

In FIGS. 10A and 11A, post X is rotated approximately 45 degrees from the other posts in FIG. 10, such as post Y. As shown, post Y has holes perpendicular to the page and ones parallel with the page (through which rods such as rod Z are inserted. Thus, at post Y, the rods are held generally parallel to the plane of the paper/page/figure. Plant P in FIGS. 10A and 11A is straight, rather than curved in FIGS. 10 and 11. Instead, the generally horizontal rods between posts X and Y are “bowed” out of the plane of FIG. 10A, as shown in FIG. 11A (if the “z-axis” is in and out of the plane of FIG. 10A, the bowing or bending is in the direction of the z-axis). The top and bottom rods between X and Y are bowed “toward” the viewer of FIG. 10A, and the middle rod Z is bowed “away” from the viewer of FIG. 10A. Rod Z also is sloped downwardly to the right as viewed in FIG. 10A, so that it can be inserted through the “non-rotated” hole in post Y and then through the “rotated” hole in post X. In another non-limiting exemplary illustration (FIG. 12) the plant support 100 has a generally rectangular overall configuration having a plurality of support rods 128 arranged in a generally parallel and perpendicular orientations that interconnect with the elongated posts 102. Persons of ordinary skill in the art will understand that the number, orientation, and distance from the ground G of the support rods can vary depending on many factors, including characteristics of the plant, number of plants, height of the plant, weight of the plant, type of support needed, location of adjacent paths and/or walkways, and/or the direction the user wishes to direct the plant growth. Also shown in FIG. 12, a preferred expanded head is molded on the upper end of the post to receive the opposing end of a similarly sized and shaped post (consistent with the preferred modular concepts disclosed herein), and is relatively simple and cost-effective to extrude and results in an integrally-formed connector element for extending the height and/or inserting/attaching other elements to the matrix 100.

In FIG. 13, another non-limiting exemplary illustration shows a plurality of elongated posts 102 each including a shaft portion 108 having an integrally molded attachment coupler 104 for mating with the shaft portion 108 of another elongated post 102. Among other things, by inserting into one or more of the couplers 104 the lower ends of appropriately sized/shaped posts 102, the height of the plant support assembly or matrix 100 can be increased, as the plant being supported grows, or initially if the plant is taller than a single post 102. Accordingly, as a plant grows or requires extra support (such as when a plant has a large blossom or bears fruit) the height of the plant support can be increased to a desired height by simply attaching additional elongated posts to the upper end of another elongated post. Persons of ordinary skill in the art likewise will understand that the height of the assembly 100 can be lowered if the upper branches of the plant(s) die or are trimmed back, and/or for aesthetic or other reasons. Persons of ordinary skill in the art further will understand that, although the posts 102 in FIG. 13 are shown with apertures 102 generally aligned so that the support rods 128 can extend in a generally straight line between respective posts 102, in other embodiments the posts 102 can be rotated out of such alignment, so that even if the posts themselves are in a straight line, the rods 128 extending between them may be flexed into a desired curved position (such as illustrated in FIGS. 10A and 11A, and FIGS. 46 and 47, for example).

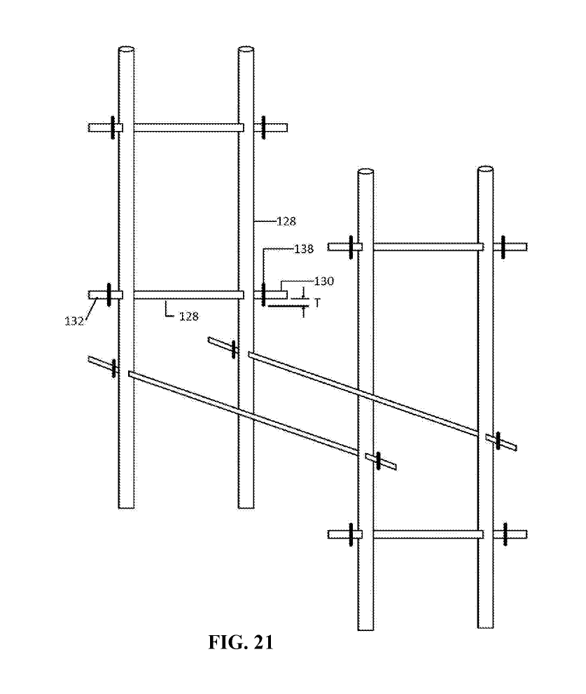

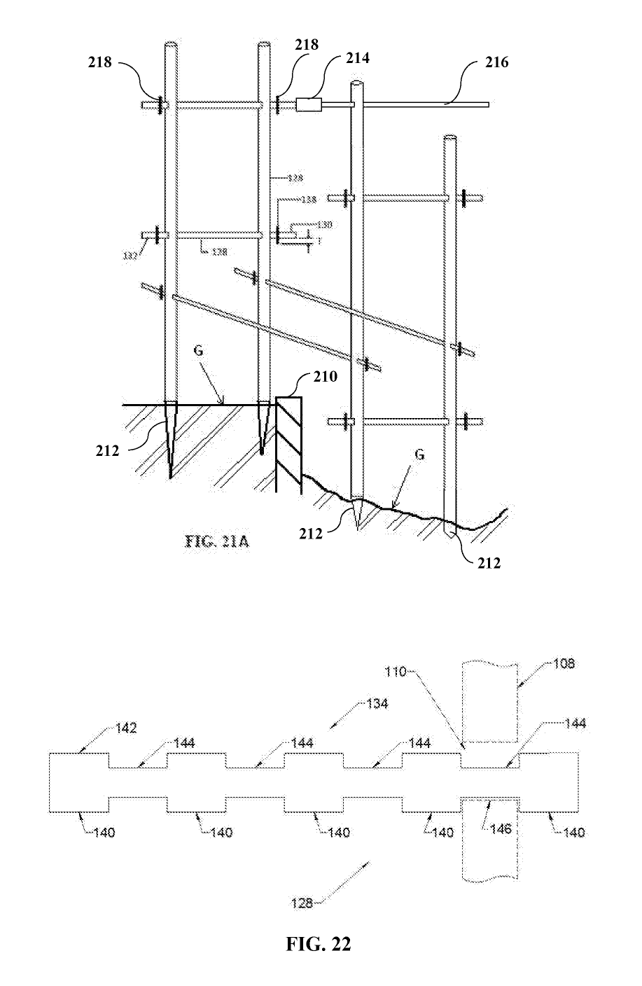

Persons of ordinary skill in the art also will understand that the length of the generally horizontal support rods 128 can likewise be adjusted, by couplers (see, for example, FIG. 21A) or similar apparatus/methods. Also, persons of ordinary skill in the art will understand that when initially assembling a matrix 100 and/or adjusting a matrix 100 to add and/or remove elements from it, the inventions preferably permit users to carefully insert/add/remove elements with a minimum of damage or risk of injury to the relevant plant(s). Thus, the system of the inventions permits users to customize the plant support matrix 100 throughout the entire life cycle and/or maintenance of a plant or plants.

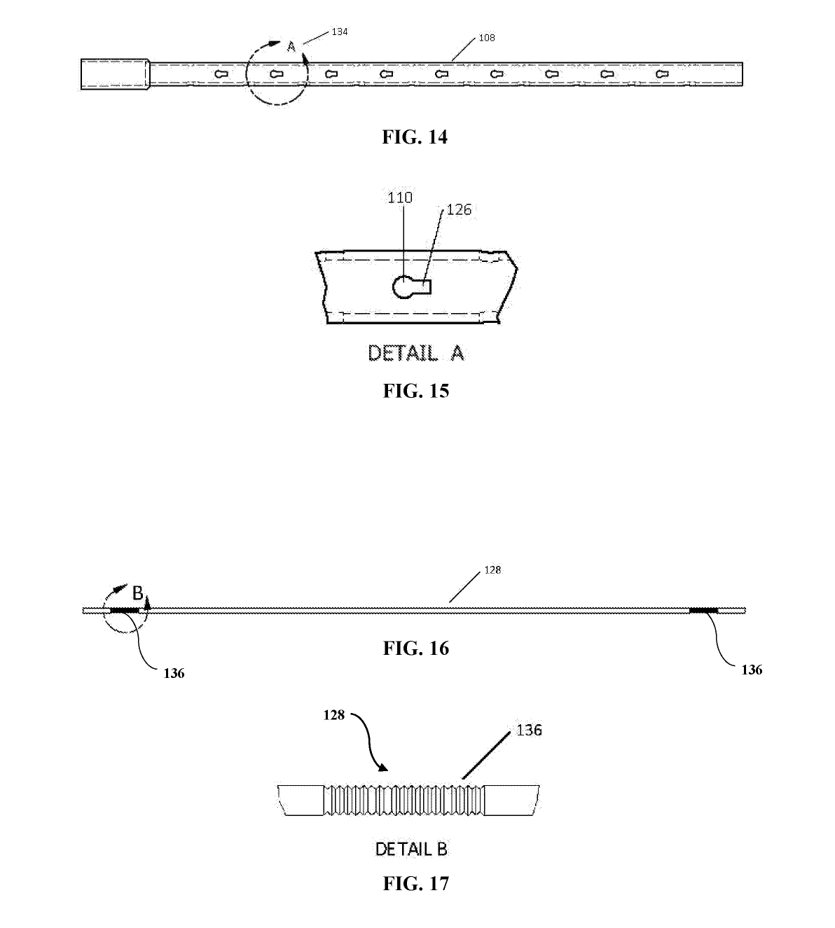

In a preferred embodiment of the invention the plant support 100 includes a securing mechanism 134 for removably securing the first end 130 and/or the second end 132 of a support rod 128 in position in relationship with respective posts 102, such as by preventing their inadvertent removal from corresponding apertures 110 of corresponding shaft portions 108 of elongated posts 102. Persons of ordinary skill in the art will understand that the nature and strength of the securement can vary widely, depending on the requirements of a specific application, the costs of fabrication of such securement elements/features, and other factors. One of the many embodiments of such a securing mechanism 134 is shown in FIGS. 14 and 15, whereby each aperture 110 of the shaft portion 108 of the elongated post 102 includes a slot 126 for receiving and securing a support rod 128. In operation, the support rod 128 is inserted into the desired aperture 110 (which is slightly larger than the cross-section of the rod 128, to permit a desired sliding insertion and adjustment). Although in certain applications one or both ends of the rod 128 can remain “loose” within their respective apertures 110, when the support rod 128 is in its desired lateral or lengthwise position with respect to the post 102, the material properties of the rod 128 and/or the slot 126 are such that the user can push downwardly on the support rod 128, such that the rod is pressed into the slot 126 forming a frictional fit thereby securing the support rod in position (frictionally engaged with the respective post 102). Preferably, the support rod 128 also can be removed from the aperture 110 (or its lateral position adjusted with respect to the post 102) by exerting an upward force on the support rod, such that the rod slides out from the slot 126, thus allowing easy removal and/or adjustment of the support rod 128. As indicated, persons of ordinary skill in the art will understand that, depending on the application, one or both ends of the rod 128 thus may be “secured” in some manner to their respective posts 102, and that such securement(s) can increase the overall stability and integrity of the assembled matrix 100 (and/or can facilitate bending or shaping the posts/rods, as disclosed herein).

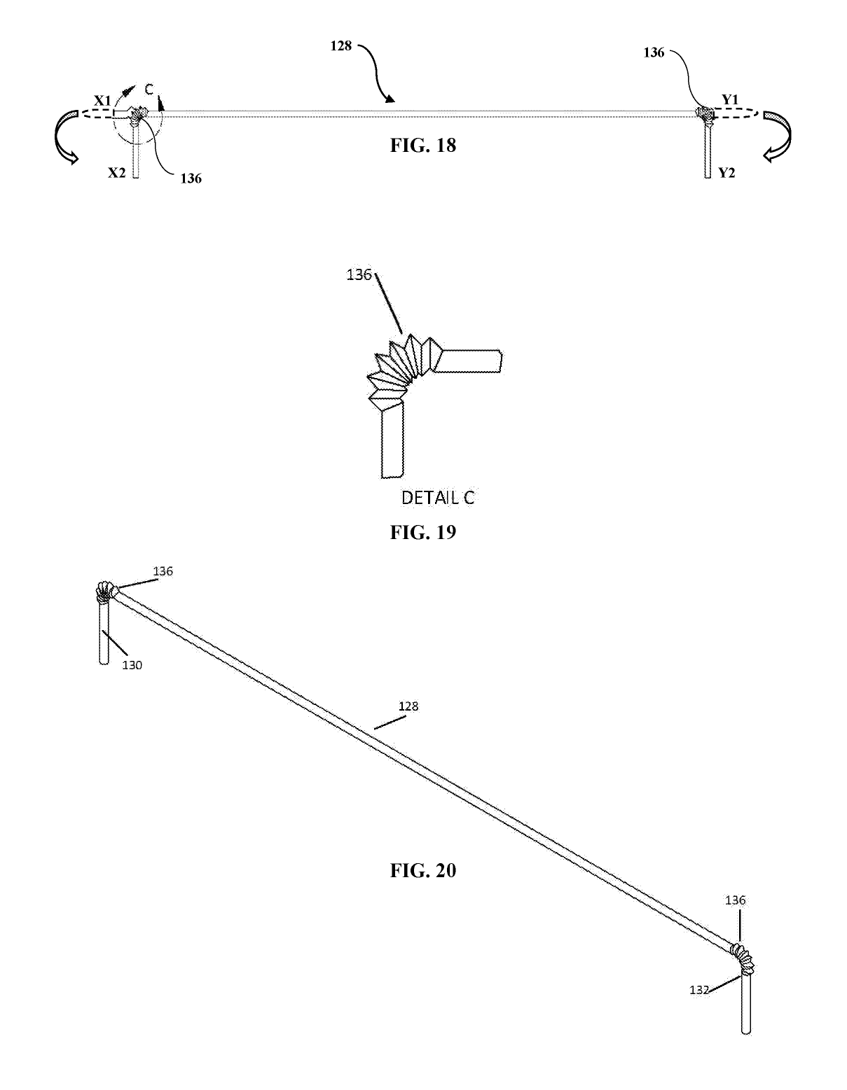

Another of the many embodiments of a securing mechanism 134 for removably and/or temporarily securing the first end 130 and/or the second end 132 of a support rod 128 in relationship with respective posts 102 is shown in FIGS. 16-20. The ends are positioned within corresponding apertures 110 of corresponding shaft portions 108 of elongated posts 102, and each end 130 and 132 of the support rod 128 include a securing mechanism 134 comprising a corrugated portion 136 which is made flexible by corrugating the peripheral surface of the support rod 128 along the portion 136 with grooves. The corrugated portion 136 is fabricated from any of a broad range of materials and techniques well known to those skilled in the art, to permit the support rod 128 to assume and maintain a desired shape at the corrugated portion 136 as the rod is bent at that location. As shown in FIG. 16, the support rod 128 is depicted in its substantially linear (unbent) arrangement. As depicted in FIGS. 18-20, the support rod 128 is bent along each corrugated portion 136 such that the first end 130 and the second end 132 are in a substantially perpendicular arrangement with respect to the remaining central portion of the rod 128. Persons of ordinary skill in the art will understand that, although the ends 130 and 132 are shown as bent “downwardly,” they can be bent in directions different from each other and still achieve a desired securement of the rod 128 with respect to the respective post 102. Accordingly, in operation, the support rod 128 is inserted into and through an aperture 110 and inner cavity 114 of shaft portion 108 in its linear arrangement such that the end 130 or 132 then extends out through a generally opposing aperture on other side of the shaft portion 108. The end 130 or 132 can then be bent along the corrugated portion 136 into their perpendicular arrangement thereby (a) preventing the support rod 128 from inadvertently disengaging from the post 102, by sliding out through the apertures 110 and (b) (in other words) securing the support rod 128 in desired engagement with the post 102.

In passing, persons of ordinary skill in the art will understand that portions of the plant(s) such as stems, branches, fruit, flowers, or the like, preferably may be readily attached to the support system or matrix 100 by any suitable means, including plant ties, string, connectors, adjustable connecting members, and the like (not shown). Preferably the invention permits the support elements to be positioned near relevant plant part(s) to facilitate desired support and/or growth/maintenance guidance, regardless of whether additional plant ties or the like are used.

Referring to FIG. 21, another of the many embodiments of the securing mechanism 134 is shown comprising bands 138, such as an elastic band, that preferably are operatively and temporarily attached (via frictional gripping or otherwise) along the first end 130 and/or the second end 132 of the support rod 128. In passing, persons of ordinary skill in the art will understand that the embodiment of FIG. 21 is shown without additional apertures in the vertical posts for selectively receiving the horizontal rods, and that the inventions can be practiced in certain embodiments such as this (without a broad selection of attachment or affixation locations). Likewise, although bands are shown on BOTH ends of the rod, persons of ordinary skill in the art will understand that, in certain embodiments, a restriction/band on a single end, or two bands adjacent opposite sides of a single vertical post, may be used. Preferably the bands 138 are placed near the shaft portion 108 of the elongated post 102 and have a thickness T or are otherwise shaped and/or positioned in a manner sufficient to prevent the ends 130 and 132 from undesirably or inadvertently sliding through apertures 110 and/or out of desired engagement with the posts 102. It should now be understood to one skilled in the art that the various embodiments of the securing mechanism as shown and described above are non-limiting exemplary illustrations and that other forms of securing mechanisms, such as clamps, clips, pins, cords, elastic washers, or other means effective for keeping the ends of a support rod from sliding through the aperture can be utilized (as further shown and discussed in connection with FIGS. 35A-35D).

FIG. 21A shows how the plant support may be provided on a terraced landscape in order to provide a matrix or matrices for plant support and guidance which extends across one or more elevations of land/plantings. FIG. 21A includes the following additional features in addition to those shown in FIG. 21: a) terraced/uneven ground G, b) an exemplary terrace “wall” 210 (shown in cross-hatching), c) varying stake 212 shapes/sizes at the bottom of each post, d) rods being “joined” at the top by a central coupler/joining element 214, e) the right-hand end of a joined/added rod 216 extending and “free hanging” out to the right, and f) that no clip/band/other retainer is required for the joined rod, as it preferably will be held laterally by the existing clips 218 on the left-hand portion of the joined pair of rods.

In another preferred embodiment of the invention, the securing mechanism 134 comprises a plurality of alternating “keyed” shapes along the surface 142 of the support rod 128, with corresponding keyed shapes in the aperture to permit selective positioning of the rod's lateral engagement with the aperture. By way of example, in FIG. 22 alternating “teeth” or protrusions or larger diameter sections 140 are formed to create a plurality of grooves 144. The larger dimension 140 is such that the entire rod 128 can be inserted into the aperture and slid therethrough to a desired lateral/horizontal position relative to the post. The larger dimension 140 preferably is too large to fit into a keyed portion of the aperture, such as slot 126 in FIGS. 14 and 15. The intermittent grooves 144, however, are sufficiently small to be slid into such slots or keys 126, with or without frictional engagement therewith. Thus, in operation, the user preferably inserts the support rod 128 into an aperture 110 of the shaft portion 108 of an elongated post 102. Once the support rod 128 is in its proper position the user presses down on the support rod 128 so that the edge 126 of the aperture mates with a groove 144 thereby securing the support rod 128 in position within the aperture 110.

Persons of ordinary skill in the art will understand that the specific shapes and locations of the “keyed” portions of the aperture/post and horizontal rod can be any of a wide variety. By way of example, in other embodiments (not shown), the teeth 140 can be on one side only of the horizontal rod, and sized so that they can only be passed through the aperture by aligning those teeth to slide through a slot such as slot 126 in FIG. 14. Once the horizontal rod is slid through to a desired location/length, the horizontal rod is “twisted” approximately 90 degrees around its longitudinal axis, so that the teeth adjacent to the vertical post “lock” the rod into position, and the rod cannot be adjusted or removed without “untwisting” the rod to again align the teeth with the slot 126.

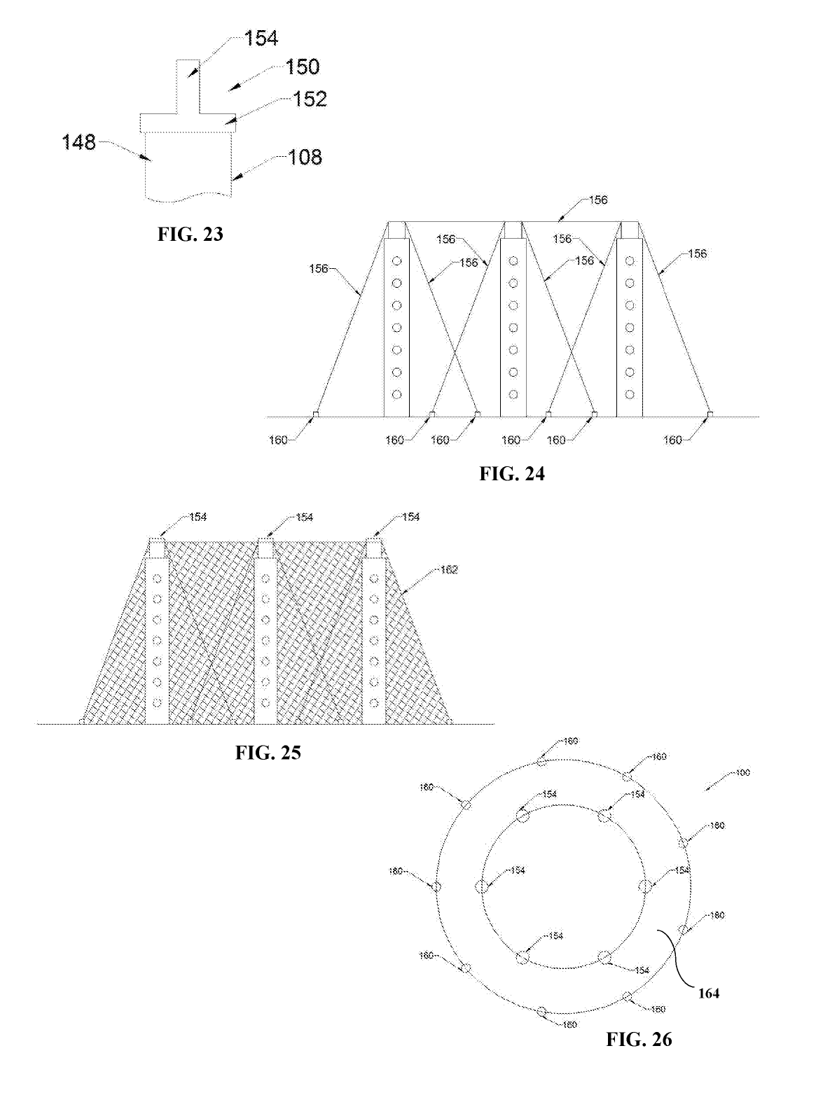

In another preferred embodiment of the plant support 100, as shown in FIG. 23, one or more of the shaft portions 108 of the elongated posts 102 each include an upper end 148 for receiving an additional securement element such as a support pin 150. Preferably, the securement element is removably attached to and/or at the upper end 148, although in certain embodiments it can be integrally formed and/or permanently attached/affixed. For embodiments such as the support pin 150, preferably the securement element comprises a mounting base 152 that extends over the upper end 148 for securing the support pin 150 in position. It should be understood that the support pin 150 can be attached to the upper end 148 by use of a friction fit or by glue or other means effective for securing the support pin 150 to the upper end 148 of the shaft portion 108. As shown the support pin 150 further comprises an elongated peg 154, although persons of ordinary skill in the art will understand that the securement element can include a wide variety of connection/securement structures to receive and/or operatively connect to supporting/protective cords, tarps, nets, or the like (as further discussed herein).

Referring to FIG. 24, another embodiment of the plant support 100 of the present inventions is shown having a plurality of cords 156 attached to one or more elongated pegs 154, with the cords effectively forming a mesh 158 for preventing or significantly reducing the risk to the plant(s) from birds and/or other animals contacting one or more of the plants being supported/protected by the plant support. Persons of ordinary skill in the art will understand that the mere presence of such cords/nets/other elements may discourage or frighten birds and/or other animals, so that they stay away from the plant(s). In certain embodiments of the inventions, cords 156 can also be attached to stakes 160 along the surface of the ground G, further reducing the risk of birds and/or other animals from contacting one or more of the plants being supported, as well as strengthening the plant support matrix 100 against winds, inadvertent contact from humans or toys, or the like. In another of the many embodiments of the inventions, as illustrated in FIG. 25 the plant support 100 comprises a screen 162 attached to one or more elongated pegs 154 effective for preventing or reducing birds, animals, and/or insects from undesirably contacting the plant(s) being supported.

It should be understood that the size and mesh size of the screen 160 can vary depending on the type of plant(s) and the birds, animals, and/or insects at issue.

In another of the many embodiments of the invention, as illustrated in FIG. 26, the plant support 100 comprises a covering or tarp 164 attached to one or more elongated pegs 154, or other securement elements. Preferably, the covering or tarp 164 extends over the elongated posts 102 and is secured along the ground by a plurality of stakes 160.

It should be understood that the covering or tarp 164 can be attached to the elongated pegs 154 of the elongated posts 102 to reduce the likelihood of injury to a plant if frost is expected or otherwise can be used to create a semi-greenhouse effect for a plant, such as during early stages of plant growth, cold or cool stretches of weather, for early or late planting/growing of plants (out of normal seasonal limits), and/or at or for other times/locations/reasons. Cooperating means (not shown) can be provided between the pegs 154 and/or other part of the matrix 100 and the tarp/net 164, to help hold the tarp/net in a desired position.

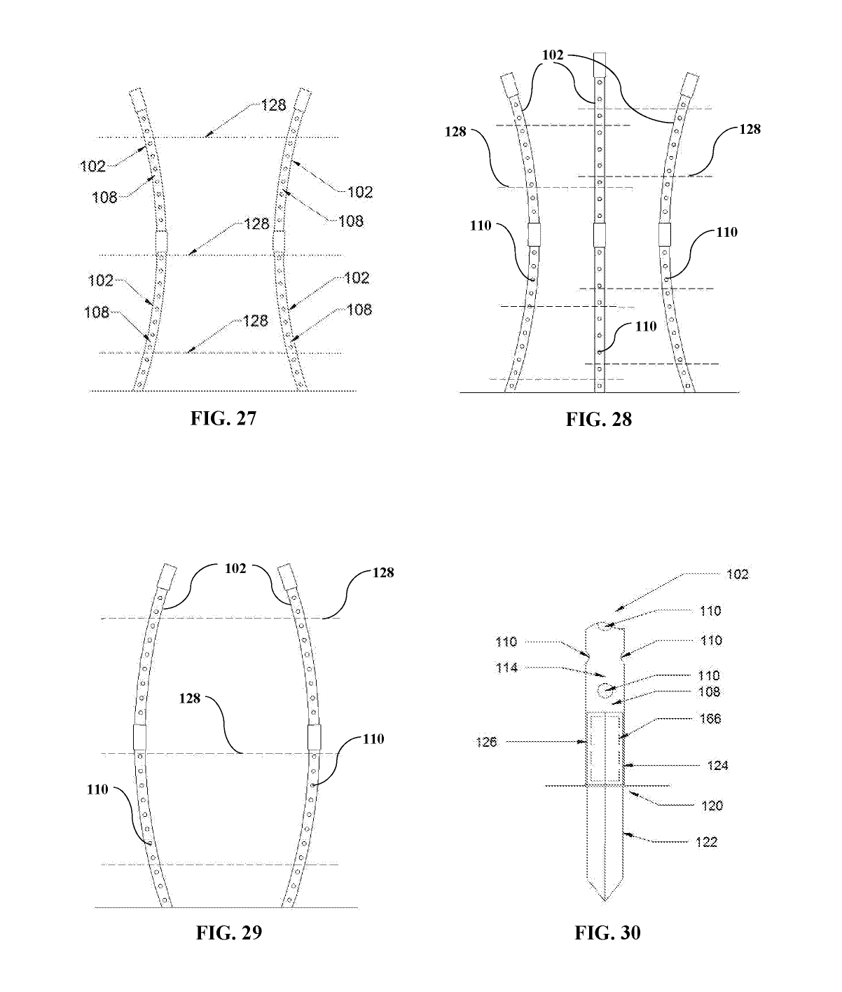

Referring to FIGS. 27, 28 and 29, another of the many embodiments of the plant support 100 is shown whereby the elongated posts 102 are shown having a curved contour. Persons of ordinary skill in the art will understand that, depending on the application, a given matrix 100 may have one or more curved posts 102 and one or more straight posts 102, all within a single structure. In one embodiment, the elongated posts 102 and/or shaft portions 108 are formed from a flexible elastic material which allows the posts 102 and/or shaft portion 108 to flex and form a curved contour. It should now be apparent to one skilled in the art that, depending on the application, the amount of flexibility of curvature can be dependent on a number of factors, including for example the length of the shaft/rod portion, the width or thickness of the shaft/rod portion, the cross-section of the shaft/rod portion, the material forming the shaft/rod portion, and/or the location and amount of bending force being applied to the shaft/rod portion. In operation, the elongated post 102 preferably is flexed to a desired curvature and a first end 130 of a support rod 128 is inserted into an aperture 110 along the shaft portion 108 of an elongated post 102 and secured in position by a securing mechanism 134, such as previously shown and described, and the second end 132 of the support rod 128 is inserted into an aperture 110 along the shaft portion 108 of another elongated post and secured in position by a securing mechanism 134 such that one or both of the elongated post(s) 102 and/or the associated rod(s) is (are) maintained in its flexed configuration. Alternatively, the posts/rods can be formed and provided with a predetermined curvature. Persons of ordinary skill in the art will appreciate that the post(s) and/or rod(s) may be made of a flexible yet durable material such as fiberglass, as one example, to achieve the desired flexibility and curvature in assembly.

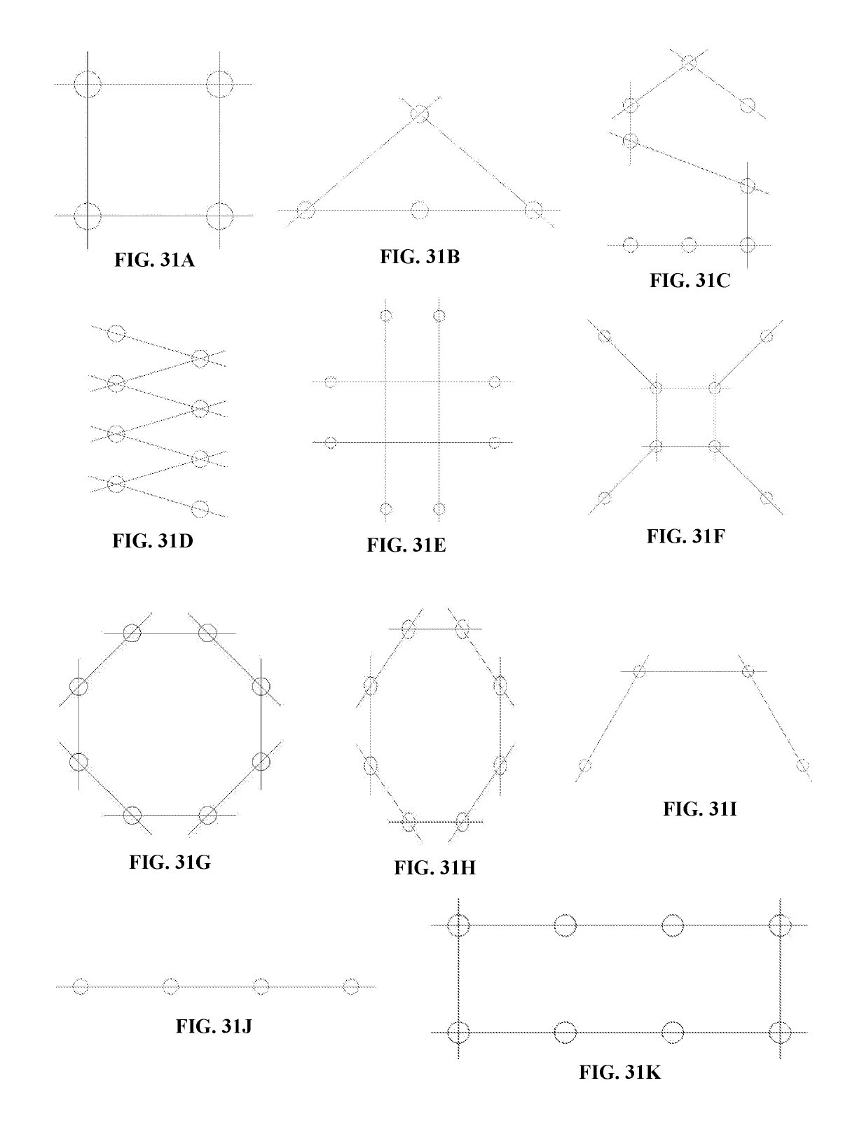

In another of the many embodiments of the invention, the plant support 100 comprises one or more support stakes 120 formed as part of or configured to readily mate with elongated posts 102. As illustrated in FIG. 30, preferably the support stake 120 includes a lower spear end 122 effective for readily inserting into the ground or soil. Persons of ordinary skill in the art will understand that the particular shape and configuration of the stake can be any of a wide range suitable for these purposes, and the materials from which the stake(s) are fabricated likewise can be any of a range of suitable materials. As mentioned above, the stake portions/elements preferably are suitably strong and lightweight and can withstand the expected forces and conditions to which they may be exposed. For separately formed stake elements, the stake(s) preferably include an upper spear end 124 configured to slide into the interior cavity 114 of the shaft portion 108 of an elongated post 102. Preferably, the diameter of the outer periphery 126 of the upper spear end 124 is the same or slightly smaller than the diameter of the interior cavity 114 such that when the upper spear end 124 is inserted into the interior cavity 114 it forms a friction fit, thereby securing the upper spear end 124 in position within the interior cavity 114.

As shown, the upper spear end 124 further may include one or more light sources 166 which operate to radiate light. Depending on the application and the materials used for the post 102, the light can be projected through translucent or other light-transmitting sidewalls and/or portions of the post 102 and/or nearby rod(s), and/or primarily into the interior cavity 114 such that the light shines out through apertures 110. Among other things, such light preferably enhances the ornamental appearance of the plant support. In certain embodiments the light is a plant light, that operates to emit an electromagnetic spectrum appropriate to enhance photosynthesis of nearby plant(s). In other embodiments the light is formed from light-emitting diodes.

Other preferred embodiments of support stakes in accordance with the present invention are shown in FIGS. 44 and 45. FIG. 44 is a schematic view of a preferred embodiment of an elongated post of the subject invention having a support stake attached thereto for securing the post in the ground. FIG. 45 is a schematic view of a preferred embodiment of a support stake of the subject invention.

It should now be apparent to one skilled in the art that the plant support of the subject invention can be easily sized and/or customized and/or modified to allow vegetation, such as a house plant, to grow easily through and around the elongated posts and support rods The use of apertures placed along the elongated posts allows the support rods to be placed such that they form open angles with the elongated posts thereby preventing or reducing the likelihood that the plant, such as a plant stem, can become wedged possibly damaging to the plant or restricting plant growth. Further, the support rods can be placed to allow the stem, branch, bud or fruit of a plant to rest on the support rod thereby providing additional support for the plant.

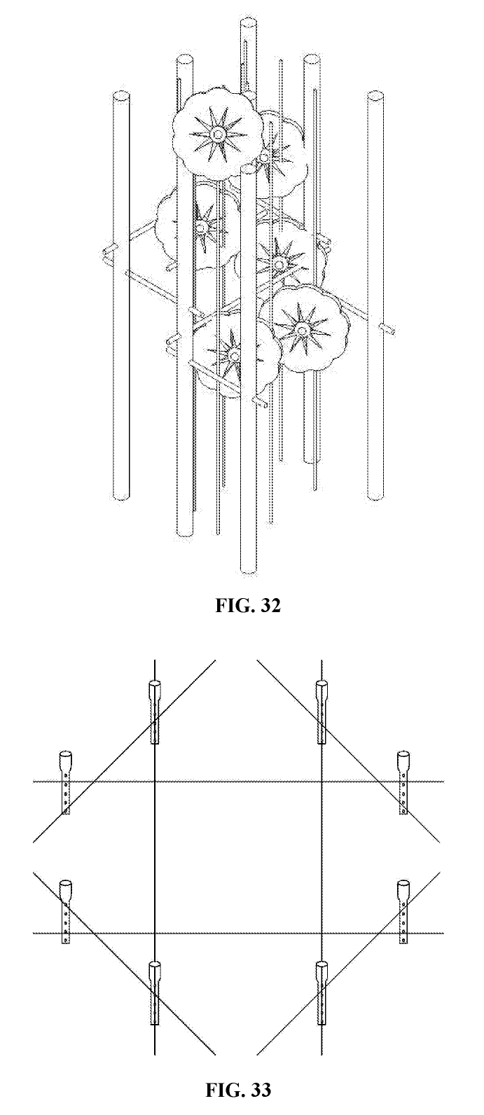

It should now be apparent that the subject invention is a new and novel plant support that can be used in a variety of ways; that enhances the appearance and growth of vegetation, by providing a supporting structure that allows plants to grow and wind itself through the various structures such as a plurality of support rods that operate to direct and support the plant; that is designed to prevent or minimize the risk of injury to the plant; and directs to plant in a manner to enhance its exposure to sunlight. Further, it should also now be apparent to one skilled in the art that by attaching the various components together such that they form an angle that minimizes shading of the plant caused by the components and maximizes the amount of sunlight reaching the plant. It should also now be apparent to one skilled in the art that the plant support of the subject invention can be easily placed into the ground and arranged in a variety of configurations. FIGS. 31A-K illustrate just some of the may possible configurations of elongated posts having support members connected thereto and forming many different geometries and dimensions of plant supports for supporting a wide variety of kinds and types of plants. As an illustration, FIG. 32 shows a flowering plant being supported by a plant support in yet another potential configuration comprised of a plurality of elongated posts having a plurality of horizontal support members being connected thereto.

As a further example, FIG. 33 illustrates yet another potential configuration whereby the placement of the elongated vertical posts and the horizontal support members being connected thereto form a grid-like space for a plant or multiple kinds of plant to grow in sections.

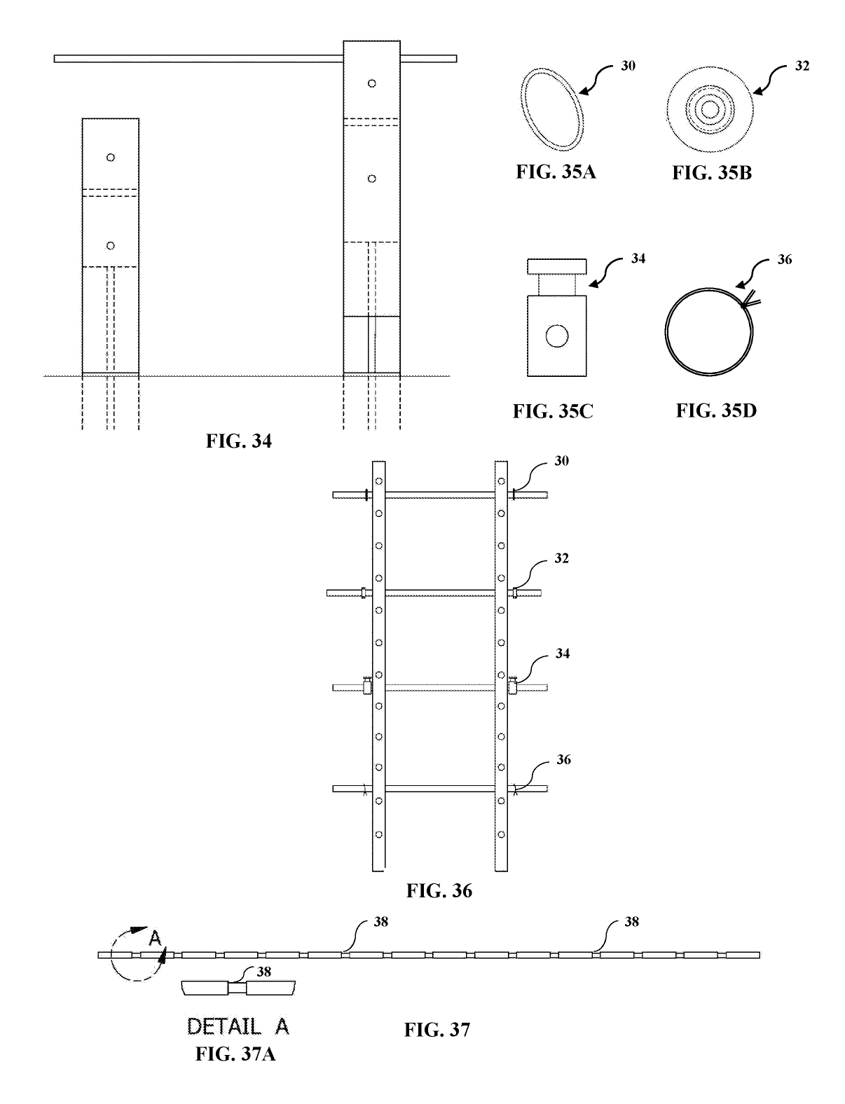

FIG. 34 also illustrates one of the many additional benefits of the inventions. If the plant or the twisting of the matrix or some other force is pulling one or more of the posts 102 of the support system 100 upwardly, such as out of engagement with the ground G and/or one or more of the starter stakes, traditional wire cages have no way of “showing” this is happening until the prior art cage/system falls over. In contrast, certain embodiments of the present inventions permit users to see if the post 102 “rises.” Users can see the starter stake exposed from the ground, and or from engagement with the respective post 102. Users then can adjust the matrix 100 to accommodate the plant growth or the other force or condition, such as by adjusting the rods to allow the post(s) to “fall back” onto the ground G or be pushed back into desired engagement with the steak or other element.

As discussed above, many different types of securing mechanisms may be used with the present invention for securing the support members in a desired relationship with the posts, such as in place within the apertures provided in the elongated posts. As illustrated in FIGS. 35A-D, some of the many possible securing mechanisms may include O-rings 30, grommets 32, tension clamps 34, and drawstring locks 36, to name a few. As further illustrated in FIG. 36, some of these example securing mechanisms are shown attached to the ends of the support members for securing the support members in place on the elongated posts. In an alternative embodiment as shown in FIG. 37, the support member may include indentations or grooves 38 in its surface at certain length intervals along its length for mating with the edges of the apertures in the posts to secure the support member in position within the apertures.

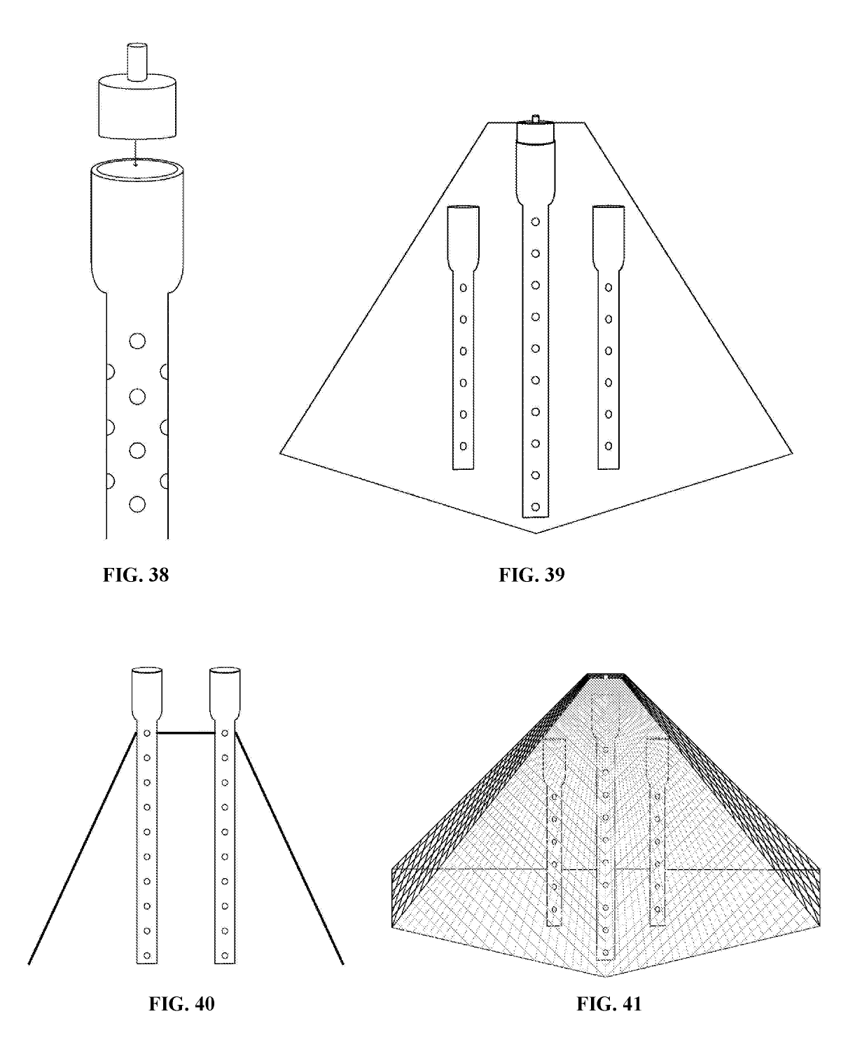

As shown in FIGS. 38-41, in certain embodiments of the present inventions, the plant support system may include tarps (FIG. 39), cords (FIG. 40), nets (FIG. 41), or the like for protecting the plants from animals, a freeze or other extreme weather, or for creating a greenhouse effect. Although persons of ordinary skill in the art will understand that such tarps or nets can simply be draped over the plants/support matrix, in other embodiments a connection element such as a support pin 150 can be provided (integrally and/or separately and/or removably such as shown) on or at an upper end of the shaft portion of the elongated post. The support pin or similar element may be used for attaching the tarp/net/cord/other element, regardless of whether the matrix is also supporting the plant itself. In other words, in certain embodiments, the matrix 100 can be used to support a tarp/net/other such protective or additional elements for the benefit of the plant(s) or otherwise. Persons of ordinary skill in the art will understand that, if the cord(s)/net(s)/other elements are staked to the ground adjacent the matrix 100, those additional elements also can further facilitate support and/or retention of the matrix in a desired location, to withstand wind, weather, and/or other inadvertent dislodgement that might damage the plant(s),

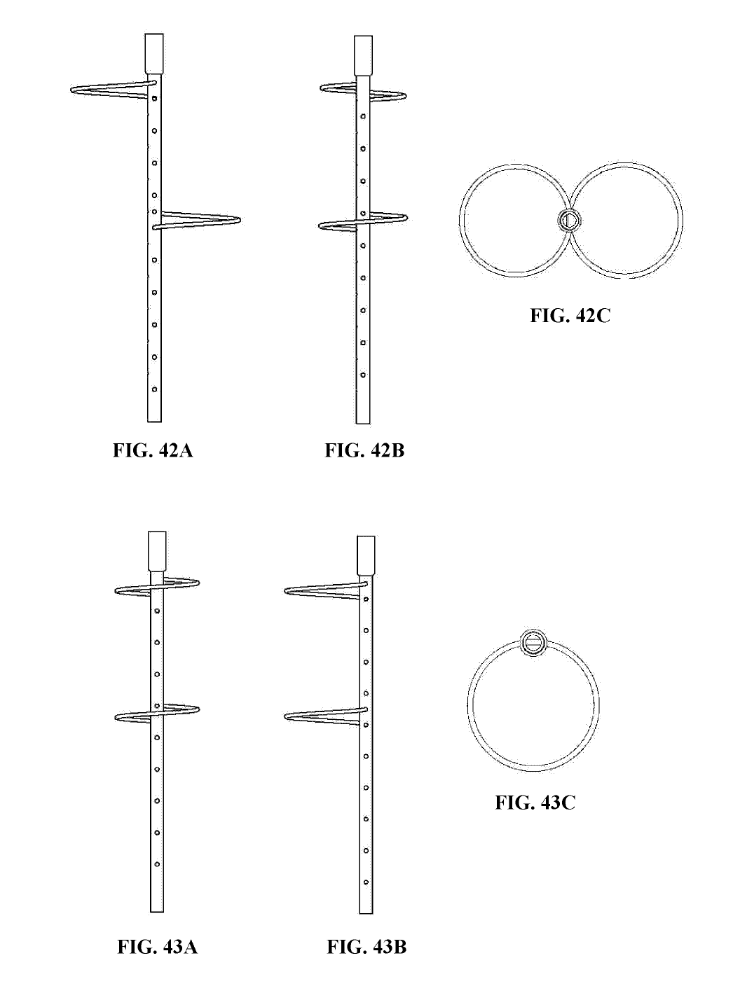

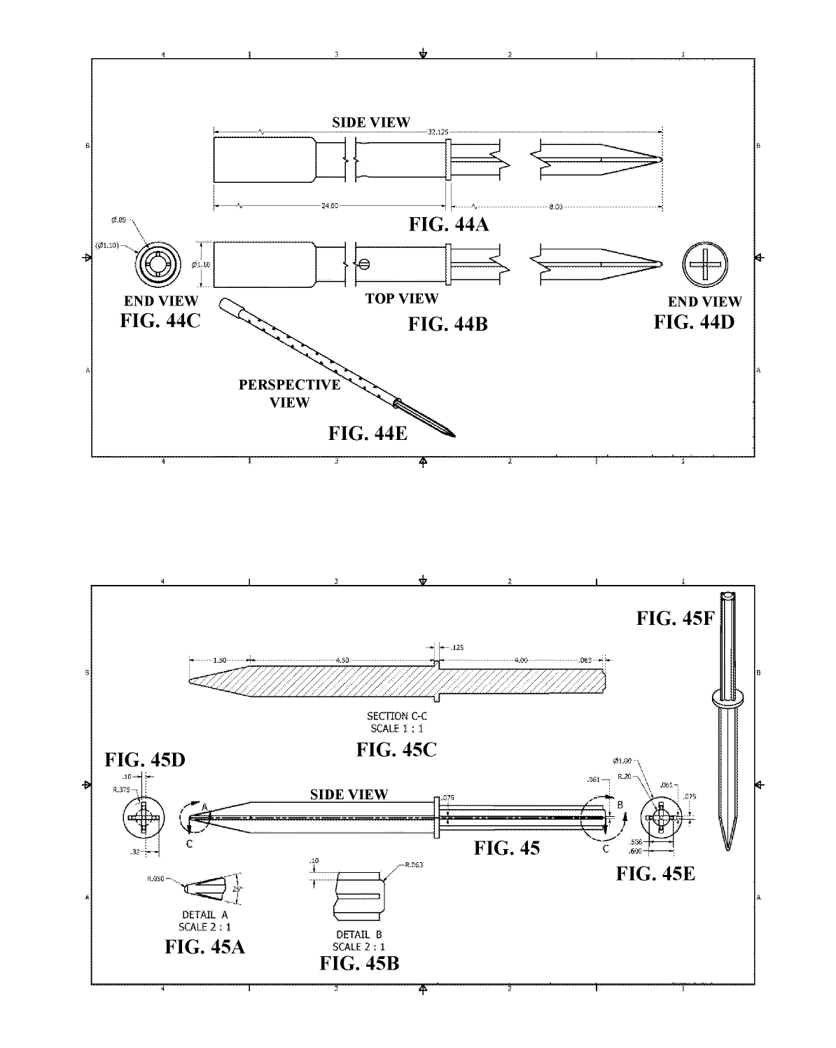

In a preferred embodiment of the present invention, a plant support may be provided as a single elongated post embodiment having one or a plurality of horizontal support members operatively and selectively positioned and retained in a relationship with the post, such as within a plurality of apertures that are provided in the post. FIGS. 42 and 43 illustrate some of the many potential single elongated post embodiments wherein the horizontal support members are curved and/or bent around the post as their first and second ends are retained within the apertures provided in the single post. In FIG. 42, for example, one support member extends laterally in a general ring-shape from the post generally within a plane that is perpendicular to the post, and in a direction opposite to the other support member. Persons of ordinary skill in the art will understand that such rings can also be at other angles around the central post, including at generally 90 degrees for embodiments such as illustrated that have apertures generally at 90 degree angles to each other. In addition, although not shown in the drawings, persons of ordinary skill in the art will understand that generally horizontal support rods can be used with a central portion of the rod affixed through or to the post, with one or more of the ends of the rod extending from the post for some distance, either in a straight or curved path. Although they may be more complicated to assemble, more complex shapes (such as “wavy” or curved) rods and/or posts (not shown) may likewise be used in certain embodiments, to provide structural strength, provide more complex structures, and/or for other reasons.

Persons of ordinary skill in the art will understand that many of the elements discussed are optional, and can be used or not depending on the particular application for which the invention(s) are being used. For example, in certain embodiments, no stakes and/or no retaining elements such as elastic bands or clamps, etc., are required. In other embodiments, a single stake and/or a single elastic band may be sufficient. In still other embodiments, the post 102 may be pushed into the ground G without any special additional stake structure.

Preferably, the posts 102 and/or the rods are provided in a normally straight and unbent configuration, for ease of manufacturing, shipping, handling, storage, and the like. Also preferably, however, both the rods and posts are flexible so that they can be positioned by a user into any of a wide range of desirable configurations. Among the many examples of such configurations are FIGS. 46A/B and 47A/B (with rods curved and/or sloped as they extend between posts). Thus, the inventions preferably permit a wide range of shapes of support structures that can be customizable by users, including rods and posts in relatively straight lines, in curved positions and configurations, in combinations of the two, and otherwise.

Any such bending of one or more of the components of matrix 100 can be accomplished in any suitable manner. By way of example, the material from which the component is fabricated can be such that it has material flexibility and/or material memory, and can be bent into one or more desired shapes. For embodiments that use Velcro or other adhesives to join the components to each other, the respective components can be bent by the user into the desired shape and then the intersecting component(s) pressed together to hold the components in that desired configuration. The bottom of one or more of the post elements can be held in a position relative to the ground G by a stake or insertion of the post into the ground or other method, and then the upper portion of the post bent into a desired configuration. In certain embodiments, even complex bends such as an S shape can be utilized. In still further embodiments, the components can be held in their desired bent configuration by a friction or interference fit, such as shown in the aforementioned FIGS. 46A/B and 47A/B. Yet another example is to hold the intersecting parts in their desired bent relationship by positioning one or more of the elastic bands, clamps, or other retaining elements at or near the respective intersection(s). For embodiments that include slots such as slot 126 discussed above, the components can be “frictionally locked” into a desired bent/curved/other configuration by moving the component into the desired shape/location and then “locking” the parts together by pressing one piece into the slot or other engagement structure on the other part.

In addition, the systems of the inventions can be used as protective elements, regardless of whether they actually support or guide any plant. The posts and or rod can be assembled into a desired arrangement near a plant, and a net or tarp draped over the assembled pieces to protect the plant from weather, animals, or other potential harm. Further in that regard, such nets and/or tarps or other devices can be simply draped over or stretched over the matrix 100, with or without any special attachment element at the upper end of one or more of the posts 102 for connecting the net or tarp to the matrix 100.

It should now be apparent to one skilled in the art that the plant support of the subject invention can be easily customized in size and/or arrangement/layout, to allow vegetation, such as a house plant, to grow easily through and around the elongated posts and support rods The use of cooperating connection elements between the rods and posts (such as apertures, Velcro, adhesive, magnets, or the like) placed along the elongated posts allows the support rods to be selectively assembled and placed such that they form only desired angles (such as obtuse angles) with the elongated posts thereby preventing or reducing the likelihood that the plant, such as a plant stem, can become wedged (via wind, growth, or otherwise) possibly damaging to the plant or restricting plant growth. Further, preferably the support rods can be selectively placed and/or moved to allow the stem, branch, bud, and/or fruit of a plant to rest on the support rod thereby providing additional support for the plant and/or part(s) of the plant.

It should now be apparent that the subject inventions provide a plant support that can be used in a variety of ways; that enhances the appearance and/or growth of vegetation, by providing a supporting structure that allows plants to grow and wind itself through the various structures such as a plurality of support rods that operate to direct and support the plant, or to provide a staggered/alternating support matrix for the plant(s) at desired locations in a dynamically changeable arrangement; that is designed to prevent or minimize the risk of damage and/or injury to the plant; and/or directs to plant in a manner to enhance its exposure to sunlight. Further, it should also now be apparent to one skilled in the art that the various components can be assembled and/or attached together such that they form an angle and/or arrangement that minimizes shading of the plant that might otherwise be caused by the components, and therefore desirably maximizes the amount of sunlight reaching the plant. It should also now be apparent to one skilled in the art that the plant support of the subject inventions can be easily placed into the ground and arranged in a variety of configurations.

As one or more plants grow, preferably the plant support 100 can be easily customized and/or modified, to accommodate and/or guide or restrict plant growth, support growing fruit or flowers on the plant(s), or for other purposes. For example, the matrix 100 can be modified by adding or subtracting the number of elongated posts, horizontal rods, or other elements, and/or by rearranging the position and/or relationship of the elongated posts/rods/other elements. For a non-limiting exemplary illustration, the elongated posts and/or support rods can be customized to be positioned to support a fragile plant that might be easily damaged by wind, by adding additional support(s) longitudinally along and/or adjacent the shaft of the plant, and/or by tying or securing part(s) of the plant to the matrix 100 that are “custom positioned” near the stem and/or branches of the plant(s). Plants having relatively heavy fruit or flowers can be provided with customized positioned support for such fruit or flowers. In addition, as plants grow, preferably the elongated posts and/or support rods can be easily lengthened and/or repositioned to accommodate the taller and/or larger plants. It should also now be apparent to one skilled in the art that by arranging the elongated posts and support rods, a plant can be directed to grow in a specific direction by either turning or bending the direction of a plant stem/branch or providing slight pressure to a stem causing the plant to grow in a desired direction.

It should also now be apparent to one skilled in the art that the plant support can be used to reduce damage to the plant(s) that might otherwise be caused by animals, birds, and/or insects, including by attaching cords and/or netting, as described, to various elongated posts forming a barrier to such animals, birds, and/or insects. Further, by attaching a tarp or similarly protective shield to the elongated posts, as described, the inventions can provide a relatively easy and inexpensive way to prevent or reduce damage to plants caused by frost, hail, excessive sun, and/or hard rain fall or other extreme weather. Further, the plant support of the subject inventions allow plants, including without limitation small plants and/or newly planted plants, to receive additional light, such as by use of plant lights, which provide such additional light as well as providing an ornamental benefit to the plant support.

It should also now be apparent that the methods described herein for attaching the various components together preferably allow the plant support to be manufactured and distributed in the form of easy to assemble and disassemble modular kits, allowing individuals to construct, expand, reduce, reconfigure, and/or otherwise use the support for a wide variety of applications, and/or over the span of many years. Further, it should now be apparent that the plant support described herein can be easily and inexpensively manufactured and assembled, and readily combined and/or expanded and/or repaired with additional components and/or kits (purchased subsequently or otherwise). Further, injection molding, extrusion, metal-fabrication (for metal embodiments) and/or other methods are among the many suitable ways for fabricating the components of the present invention.

Although the foregoing inventions have been described in some detail for purposes of clarity of understandings, it will be apparent that certain changes and modifications may be practiced within the scope of the appended claims. Accordingly, it should be understood that the present disclosure is to be considered as exemplary of the principles of the inventions and is not intended to limit the inventions to the embodiments and the specific examples illustrated and the inventions are not to be limited to the details given herein, but may be modified within the scope and equivalents of the descriptions and examples contained herein.

Various modifications and alterations of the inventions will become apparent to those skilled in the art without departing from the spirit and scope of the inventions, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present inventions have been described above, it should be understood that they have been presented by way of example only, and not of limitation. Likewise, the various diagrams may depict an architectural or other exemplary configuration for the inventions, which is done to aid in understanding the features and functionality that may be included in the inventions. The inventions are not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the present inventions. Also, a multitude of different names other than those depicted herein may be applied to the various module, elements, and/or partitions. Additionally, with regard to flow diagrams, operational descriptions, and/or method claims, the order in which the steps are presented herein shall not mandate that various embodiments be implemented to perform the recited functionality in the same order unless the context dictates otherwise.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read (depending on the context) to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or (again, depending on the context) at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments. In other words, the present inventions are not intended to be limited to the embodiments shown herein but are intended to be accorded the widest lawful scope consistent with the principles and novel features disclosed herein.

1. Apparatus providing support to a growing plant, including:
an elongated post having a longitudinal axis extending between first and second ends, said first end being supported on a surface from which the plant grows adjacent to the post;
said post having a plurality of pairs of holes along its length and spaced radially from the longitudinal axis, a first hole of a given pair being spaced radially on one side of the longitudinal axis and the other hole of the pair being radially spaced on the other side of the longitudinal axis;
said holes configured to receive and retain in operative engagement with the post at least one horizontal member, a first end of said horizontal member received in a first pair of holes of the post and a second end of said horizontal member received in a second pair of holes of the post.

2. The apparatus of claim 1, wherein the first and second pairs of holes are the same pair of holes.

3. The apparatus of claim 1, wherein the first pair of holes is different from the second pair of holes.

4. The apparatus of claim 1, wherein the second end of said horizontal member is further received in at least one other pair of holes along the length of the post.

5. The apparatus of claim 1, wherein the horizontal member is configured to bend about the post from the first pair of holes to the second pair of holes.

6. The apparatus of claim 1, further including a securing mechanism for securing the first and second ends of said horizontal member within the first and second pairs of holes of the post.

7. The apparatus of claim 1, further including a stake positioned at the first end for securing the first end to the surface from which the plant is growing.

8. A method of gardening, including:
providing the apparatus of claim 1 to provide support to at least one plant growing from a surface;
securing the first end of the elongated post to the surface adjacent to the plant; and
inserting the first and second ends of said horizontal member into the first and second pairs of holes of the post so that at least a portion of the horizontal member makes contact with a part of the plant.

9. A plant support comprising:
two or more elongated posts each having a plurality of apertures;
one or more support rods, each support rod having a first end inserted into a first aperture in one elongated post and a second end inserted into a second aperture in another elongated post;
a securing mechanism securing said first end in relation to said first aperture and a securing mechanism securing said second end in relation to said second aperture.

10. The plant support of claim 9 wherein said one or more support rods contact and/or support a plant.

11. The plant support of claim 9 wherein said one or more support rods exert a force on the plant to direct and/or limit the growth of the plant.

12. The plant support of claim 9 further comprising one or more stakes adapted for mating with corresponding ones of said elongated posts, said one or more stakes configured for insertion into the ground.

13. The plant support of claim 9 wherein at least one of said securing mechanisms comprises a locking slot connected to an adjacent aperture, said slot operating to maintain the support rod in a selected position within the aperture.

14. The plant support of claim 9 wherein said at least one of securing mechanisms comprises a corrugated portion along first and/or second end of the one or more support rods, said corrugation making that portion of the support rod relatively flexible and/or bendable to provide interfering engagement and retention of the respective rod with the respective post.

15. The plant support of claim 9 wherein said securing mechanism comprises a band, clamp, clip, pin, cord, elastic washer, or other means effective for keeping said end of said support rod from sliding out of the desired engagement with said aperture.

16. The plant support of claim 9 wherein said securing mechanism comprises a plurality of keyed elements formed along said support rod for mating with corresponding structure of said aperture, to secure said support rod in a desired longitudinal position with respect to the respective post.

17. The plant support of claim 9 further comprising a net that extends over the plant.

18. The plant support of claim 9 wherein said net comprises a mesh sized to reduce the likelihood of insects penetrating the net.

19. The plant support of claim 9 further comprising a plurality of cords that reduces the likelihood of birds from making contact with the plant.

20. The plant support of claim 9 further comprising a tarp extending over the plant.

21. The plant support of claim 20 wherein said tarp is a transparent or translucent.

22. The plant support of claim 9 wherein one or more of said elongated posts include an upper insert attached to a net and/or a tarp.

23. The plant support of claim 9 wherein said individual elongated posts and support rods are assembled such that they are connected together to form an angled orientation with each other.

24. The plant support of claim 9 wherein said elongated posts are flexible such that they can bow to form a curved configuration.

25. The plant support of claim 9 further comprising an attachment coupler that attaches two elongated posts together longitudinally forming a unified post having a desired length.

26. The plant support of claim 9 further comprising one or more lights within one or more posts that operate to enhance the ornamental appearance of the plant support.

27. The plant support of claim 26 wherein said one or more lights operate to emit an electromagnetic spectrum appropriate to enhance photosynthesis.

28. The plant support of claim 26 wherein said one or more lights are light-emitting diodes.
